(19) United States
(12) Patent Application Publication
(10) Pub. No.: US 2017/0042082 A1
(43) Pub. Date: Feb. 16, 2017

(54) OSMOREGULATING COATED SEED AND METHOD

(71) Applicant: AQUATROLS CORPORATION OF AMERICA, Paulsboro, NJ (US)

(72) Inventors: Mica Franklin McMILLAN, Davie, FL (US); Stanley J. KOSTKA, Cherry Hill, NJ (US)

(21) Appl. No.: 15/305,359

(22) PCT Filed: Apr. 24, 2015
(86) PCT No.: PCT/US15/27600

§ 371 Date: Oct. 20, 2016

Related U.S. Application Data
(60) Provisional application No. 61/984,731, filed on Apr. 25, 2014.
(60) Provisional application No. 61/985,219, filed on Apr. 28, 2014.

(51) Int. Cl. A01C 1/06

(52) U.S. Cl. CPC A01C 1/06

(57) ABSTRACT

An osmotic regulator coated seed having enhanced seed germination and plant development is provided. The coated seed has a coating that includes an osmotic regulator that promotes seed germination, seedling emergence, seedling vigor, percent ground coverage, and/or stand density, even when the seed is subjected to abiotic stress conditions, or to reduced availability of water because of deficit irrigation techniques or soils that do not readily absorb or retain water. A method for making and planting such a coated seed are also provided.

### CROSS REFERENCE TO RELATED APPLICATIONS

This application claims the benefit of U.S. Provisional Application No. 61/984,731, filed on 25 Apr. 2014 and U.S. Provisional Application No. 61/985,219, filed on 28 Apr. 2014, the contents of each of which are incorporated by reference herein.

### BACKGROUND OF THE DISCLOSURE

1. Field of the Disclosure

The present disclosure relates to an osmoregulating coated seed having enhanced seed germination and plant development. More particularly, the present disclosure relates to a seed having an osmoregulating coating that includes an amino acid complex that enhances seed germination, seedling emergence, seedling vigor, percent ground coverage, and/or stand density, even when the seed is subjected to abiotic stress conditions, or to reduced availability of water because of deficit irrigation techniques or soils that do not readily absorb or retain water. A method for making such a coated seed is also provided.

2. Description of Related Art

A seed is an embryonic plant. Germination is the process by which a seed develops into a seedling. In order for a seed to germinate, the seed must be alive and viable, dormancy requirements must be met, and the proper environmental conditions must exist. Viability is the ability of the embryo to germinate. Numerous factors contribute to viability of a seed, including environmental conditions and environmental stressors. Basic environmental conditions include, water, oxygen, temperature, and light. Environmental stressors are environmental conditions that stress the seed and thus decrease the likelihood that the seed will germinate and develop into a seedling. Seed germination and emergence are influenced by water and oxygen availability, temperature, nutrition, and biological activity in the root zone. Many types of seeds are sensitive to their growing environments and require good environmental conditions in order to properly germinate and develop.

Seed germination can be diminished by inadequate availability of irrigation water and/or rainfall, and by poor quality of water (e.g., water having high salinity). This problem is further exacerbated in soil that repel water, and in soils that do not retain water well, such as sand soils.

Abiotic stress conditions can also influence seed germination and viability. Abiotic stress can refer to several different kinds of environmental stress, including temperature stress, such as very high-temperature or low-temperature conditions, salt stress, such as high-salinity water, water stress, such as drought stress or excessive moisture stress, and oxidative stress. Seeds that are subjected to abiotic stress can have reduced cellular physiological function and may not fully develop. Even seeds that manage to germinate when subjected to abiotic stress may show decreased physiological cellular functioning.

In addition to environmental stress factors, seed germination and development can be affected by deficit irrigation techniques. Deficit irrigation techniques are employed to conserve and optimize the use of irrigation water and rainfall, but can also reduce the availability of water to the seed and thereby diminish seed germination and development.

Agriculture, in particular, is highly dependent on specific climate and environmental conditions. As climates change and shift, many regions will experience declines in crop production due to induced abiotic stress conditions resulting from these changes in environment. Consequences also include shifting seasons and more extreme weather events.

Various soil wetting agents with nutrients that are sprayed onto soil are not economically feasible on a large scale. They require very high rates of application. Further, these sprays do not have an immediate effect on a seed, and much of the spray is consumed by microorganisms in the soil. Yet further, by spray applications onto soil, is a seed does not have direct access, and access is further reduced by water runoff and photo effects.

Accordingly, there is an urgent need for ways that ameliorate the negative effects of these abiotic stress conditions on seeds, germination, and seedling growth. Particularly advantageous would be seed coating that, among other things, provides osmotic regulation to facilitate water and nutrient flow into the seed, so that the seed can be provided with an optimum growing microenvironment even under conditions that would otherwise be stressful and prohibit germination or reduce yield.

As used herein, an osmotic regulator is a substance that when in contact with a seed, assists with transport of water and nutrients into the seed, maintains a homeostasis of the seed's water content, and protects membranes in or on the seed.

### SUMMARY OF THE DISCLOSURE

The present disclosure provides a seed that has an osmotic regulator coating in direct contact with a seed.

An agricultural composition is also provided. The composition has a seed having an outer layer and an osmotic regulator coating in contact with the outer layer of the seed. The osmotic regulator coating comprises between about 0.5-20% of a weight of the seed. The seed exhibits enhanced seed germination compared to an uncoated seed.

The osmotic regulator coating can substantially uniform about the seed. The osmotic regulator coating can have between about 2-10% calcium and 6-15% nitrogen.

The seed with the osmotic regulator coating also exhibits enhanced seed germination under abiotic stress compared to an uncoated seed under abiotic stress.

The enhanced seed germination yields a seedling with faster emergence, more vigor, increased ground coverage, and/or increased stand density compared to a seedling emerging from an uncoated seed.

The osmotic regulator coating can be made of at least two separate sublayers, each sublayer having a different component. The component for each sublayer can be an amino acid complex, activated carbon, calcium nitrate, potassium nitrate, and polyvinyl acetate.

The osmotic regulator coating can alternatively be made of a homogenous layer comprising an amino acid complex and at least one other component selected from the group consisting of: activated carbon, calcium nitrate, potassium nitrate, and polyvinyl acetate.

An outer coating can be disposed about the osmotic regulator coating and the outer coating can be diatomaceous earth. Such outer coating can encapsulate the osmotic regulator coating. The outer coating can also have polyvinyl alcohol (PVA), polymers and copolymers of polyvinyl acetate, vinylidene chloride, methyl cellulose, acrylic, cellulose, polyvinylpyrrolidone, and/or polysaccharide. The outer coating can also comprise between about 5-10% weight of polyvinyl acetate to weight of seed.

An agricultural composition is also provided wherein the osmotic regulator coating comprises an amino acid complex. The osmotic regulator coating can also have between about 2-10% calcium and 6-15% nitrogen.

An agricultural composition is provided where the osmotic regulator coating is surfactant free. An agricultural composition is also provided where the entire composition is surfactant free.

As used in this application, a seed is any variety of seed such as grass, fruit, vegetable, corn, wheat, and the like.

The afore or after mentioned agricultural compositions can further comprise an activated carbon coating disposed between the osmotic regulator coating and the outer coating. The activated carbon coating can be present between about 15-20% weight of activated carbon to weight of seed.

A method of making the agricultural composition is also provided. A plurality of seeds, an amino acid complex, and an aqueous solution of between about 5-12% polyvinyl alcohol are mixed, thus forming an osmotic regulator coating that is in contact with an outer layer of each seed. The osmotic regulator coating is present in a range of between about 0.5-20% weight of osmotic regulator coating to weight of seed, and the polyvinyl alcohol is present in a range between about 10-30% weight of aqueous solution to weight of see. An additional 10-30% weight of aqueous solution to weight of seed of polyvinyl alcohol and a quantity of diatomaceous earth are admixed, onto the first coating, until dry.

The mixing and admixing can be performed in a seed coater, preferably using centrifugal forces. The method can also involve admixing activated carbon onto the first coating in a quantity that is in a range between about 10-30% weight of activated carbon to weight of seed.

Further provided is a method of planting the agricultural composition. This includes planting, in an environment, a seed according to the present disclosure in an environment having abiotic stressors, an environment having reduced water availability, an environment undergoing deficit irrigation techniques, a sandy soil environment, a high salinity soil environment, and/or a fire ravaged soil environment.

The present disclosure also provides that the osmotic regulator coating can also include calcium and nitrogen compounds in addition to the amino acid complex.

The present disclosure also provides that the seed coating is substantially uniformly disposed on the seed, and encapsulates the seed.

The present disclosure further provides an amino acid coated seed having a first coating disposed thereon that is an amino acid complex, and a second coating disposed on the outside of the first coating, which can include diatomaceous earth, limestone, clay and/or a binder.

The present disclosure still further provides that the first coating and/or second coating can include activated carbon, which assists in drying of the seed coating.

The amino acid coated seed demonstrates enhanced seed germination, seedling emergence, seedling vigor; percent ground coverage, and/or stand density. Also observed are faster germination times, higher resistance of the seed to environmental stress, increased speed to establishment, and/or growth rate. The enhancements are present even when the seed is subjected to abiotic stress conditions, reduced water availability, deficit irrigation techniques, sandy soils, high saline conditions, fire-ravaged soils, or generally poor water and soil quality conditions, as well as under normal growing conditions.

### BRIEF DESCRIPTION OF THE DRAWINGS

FIG. 1 is an illustration of an embodiment of an amino acid coated seed of the present disclosure.

FIG. 2 is an illustration of another embodiment of an amino acid coated seed of the present disclosure.

FIG. 3 shows the results of a study using the amino acid coated seed of the present disclosure.

FIG. 4 shows the results of a study using the amino acid coated seed of the present disclosure.

FIG. 5 shows results from a study using the amino acid coated seed of the present disclosure.

FIG. 6 shows results from a study using the amino acid coated seed of the present disclosure.

FIG. 7 shows results from a study using the amino acid coated seed of the present disclosure.

FIG. 8 shows results from a study using the amino acid coated seed of the present disclosure.

FIG. 9 shows results from a study using the amino acid coated seed of the present disclosure.

FIG. 10 shows results from a study using the amino acid coated seed of the present disclosure.

FIG. 11 shows results from a study using the amino acid coated seed of the present disclosure.

FIG. 12 shows results from a study using the amino acid coated seed of the present disclosure.

FIG. 13 shows results from a study using the amino acid coated seed of the present disclosure.

FIG. 14 shows results from a study using the amino acid coated seed of the present disclosure.

FIG. 15 shows results from a study using the amino acid coated seed of the present disclosure.

FIG. 16 shows results from a study using the amino acid coated seed of the present disclosure.

FIG. 17 shows results from a study using the amino acid coated seed of the present disclosure.

FIG. 18 shows results from a study using the amino acid coated seed of the present disclosure.

FIG. 19 shows results from a study using the amino acid coated seed of the present disclosure.

FIG. 20 shows results from a study using the amino acid coated seed of the present disclosure.

FIG. 21 shows results from a study using the amino acid coated seed of the present disclosure.

FIG. 22 shows results from a study using the amino acid coated seed of the present disclosure.

FIG. 23 shows results from a study using the amino acid coated seed of the present disclosure.

FIG. 24 shows results from a study using the amino acid coated seed of the present disclosure.

FIG. 25 shows results from a study using the amino acid coated seed of the present disclosure.

FIG. 26 shows results from a study using the amino acid coated seed of the present disclosure.

### DETAILED DESCRIPTION OF THE DISCLOSURE

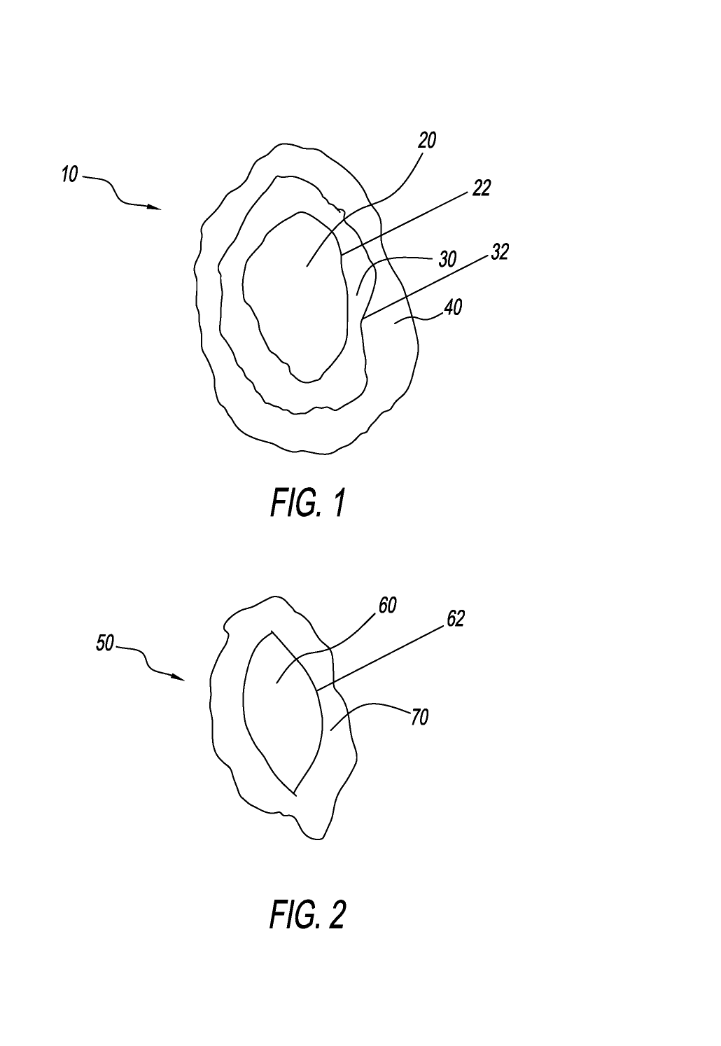

Referring to the drawings and, in particular, FIG. 1, there is shown an osmotic regulator coated seed generally represented by reference numeral 10. Osmotic regulator coated seed 10 includes a seed 20 having an outer layer 22 (i.e., the seed coat). A first coating 30 (also called “osmotic regulator coating” and an “inner coating” in this application) having an outer surface 32 is disposed on outer layer 22. A second coating 40 (also called an outer coating herein) can be disposed on outer surface 32.

In a preferred embodiment, first coating 30 is disposed and in contact on the entire outer layer 22 of seed 20 and completely encapsulates seed 20 therein. In an alternative embodiment, first coating 30 is disposed and in contact with only a first portion of outer layer 22, leaving a second portion of outer layer 22 uncovered by first coating 30.

In a preferred embodiment, first coating 30 has a thickness that is uniform, or substantially uniform, around the entire outer layer 22 of seed 20. In an alternative embodiment, first coating 30 has a variable thickness, and is considerably thicker on some portions of outer layer 22 than on other portions.

In a preferred embodiment, first coating 30 is made of a composition that forms a single layer that is homogeneous. In an alternative embodiment, first coating 30 is made of two or more separate, adjacent sublayers (not shown), in which each individual sublayer is a homogeneous mixture of two or more components of first coating 30, or, alternatively, in which each sublayer is a single component that is a different composition from the sublayer immediately adjacent thereto.

Similarly, in a preferred embodiment, second coating 40 is disposed on the entire outer surface 32 of first coating 30, and completely encapsulates first coating 30 and seed 20 therein. In an alternative embodiment, second coating 40 is disposed only on a first portion of outer surface 32, leaving a second portion of outer surface 32 that is uncovered by second coating 40.

In a preferred embodiment, second coating 40 has a thickness that is uniform, or substantially uniform, around the entire outer surface 32. In an alternative embodiment, second coating 40 has a variable thickness, and is considerably thicker on some portions of outer surface 32 than on other portions.

In a preferred embodiment, second coating 40 is made of a composition that forms a single layer that is homogeneous. In an alternative embodiment, second coating 40 is made of two or more separate, adjacent sublayers (not shown), in which each individual sublayer is a homogeneous mixture of two or more components of second coating 40, or, alternatively, in which each sublayer is a single component that is a different composition from the sublayer immediately adjacent.

Referring now to FIG. 2, there is shown another embodiment of an osmotic regulator coated seed generally represented by reference numeral 50. Osmotic regulator coated seed 50 includes a seed 60 having an outer layer 62 (i.e., the seed coat). A first coating 70 is disposed on outer layer 62.

First coating 30 (or first coating 70) has an osmotic regulator coating. Osmotic regulators can include hormones such as Abscisic acid (ABA), proline, an amino acid complex, synthetic ABA, and the like.

An amino acid complex (also referred to as “AAC” herein) has one or more amino acids including, but not limited to, alanine, arginine, asparagine, aspartic acid, cysteine, glutamic acid, glutamine, glycine, histidine, lysine, methionine, proline, serine, threonine, tryptophan, and valine, and any combinations thereof. The amino acid complex in first coating 30 preferably includes all sixteen amino acids above, namely, alanine, arginine, asparagine, aspartic acid, cysteine, glutamic acid, glutamine, glycine, histidine, lysine, methionine, proline, serine, threonine, tryptophan, and valine. In an alternative embodiment, the amino acid complex in first coating 30 is made of any combination of 2, 3, 4, 5, 6, 7, 8, 9, 10, 11, 12, 13, 14, or 15 of the amino acids selected from alanine, arginine, asparagine, aspartic acid, cysteine, glutamic acid, glutamine, glycine, histidine, lysine, methionine, proline, serine, threonine, tryptophan, and valine. The amino acid complex can also include one or more of the other amino acids not listed above, including, but not limited to, isoleucine, leucine, phenylalanine, and tyrosine.

The individual amino acids present in the amino acid complex in first coating 30 (or first coating 70) can be specifically selected for their effects on a seed. For example: Alanine, which is a precursor to alanine betaine, protects against dehydrative stress; Arginine, which is a primary precursor to polyamines which protect plants against internal pH stresses resulting from external stress, such as drought stress; Asparagine, which is a basic amino acid used in plant Nitrogen storage, transport and/or transfer processes; Aspartic Acid, which is a basic amino acid used in plant Nitrogen storage, transport and/or transfer processes; Cysteine, which combines with glutamate to form glutathione that absorbs free radicals commonly formed during stress events; Glutamic Acid, which is a basic amino acid used in plant Nitrogen storage, transport and/or transfer processes; Glutamine, which is another basic amino acid used in plant Nitrogen storage, transport and/or transfer processes; Glycine, which combines with glutamate to form glutathione that absorbs free radicals commonly formed during stress events; Histidine, which affects micro nutrient chelation and plant development, namely, flowering and fruit set; Lysine, which is important in sulfur utilization, the production of ethylene and plant defense polyamines which protect plants against internal pH stresses resulting from external stress, such as drought stress; Methionine, which is important in sulfur utilization, the production of ethylene and plant defense polyamines which protect plants against internal pH stresses resulting from external stress, such as drought stress; Proline, which is the primary compound used to combat water deficits in plants, and which is highly water-soluble and accumulates rapidly in water-stressed leaves, which can represent more than 50% of the osmotic adjustment in stressed tissues, which also protects membranes and proteins under hydration stress, and which is also a ready source of energy once the stress has passed; Serine, which is a precursor to choline then glycine betaine and is the second most important dehydration avoidance compound after Proline; Threonine, which is important in sulfur utilization, the production of ethylene and plant defense polyamines which protect plants against internal pH stresses resulting from external stress such as drought stress; Tryptophan, which is a precursor of indole-acetic acid or auxin biosynthesis, auxin being a growth hormone controlling root initiation and leaf growth; and Valine, which is associated with increasing levels in turf grass under water stress. In particular, application of tryptophan has shown to increase drought tolerance. Under saline conditions, proline, phenylalanine, serine, valine, glutamic acid, or threonine can be found in higher concentrations and can act as a drought avoidance mechanism. Arginine, histidine, and aspartic acid can reduce oxidative stress.

In certain embodiments according to the present disclosure, Alanine is present in a range between about 4.5-13.7%, preferably between about 6.8-11.5%, and more preferably between about 8.2-10.5%. Arginine is present in a range between about 3.3-9.9%, preferably between about 4.9-8.3%, and more preferably between about 5.9-7.3%. Asparagine is present in a range between about 1.1-18.3%, preferably between about 2.3-15.7%, and more preferably between about 3.8-13.1%. Aspartic acid is present in a range between about 3.1-9.4%, preferably between about 4.6-7.8%, and more preferably between about 5.6-6.9%. Cysteine is present in a range between about 0.1-3.1%, preferably between about 0.2-2.5%, and more preferably between about 0.2-1.2%. Glutamic acid is present in a range between about 6.8-20.4%, preferably between about 10.1-16.9%, and more preferably between about 12.2-14.9%. Glutamine is present in a range between about 2.1-26.2%, preferably between about 3.3-25.1%, and more preferably between about 5.1-22.9%. Glycine is present in a range between about 9.7-29.1%, preferably between about 14.5-24.3%, and more preferably between about 17.4-21.4%. Histidine is present in a range between about 0.4-8.6%, preferably between about 0.5-3.3%, and more preferably between about 0.8-2.3%. Lysine is present in a range between about 1.1-3.3%, preferably between about 1.6-2.7%, and more preferably between about 1.9-2.4%. Methionine is present in a range between about 0.1-4.1%, preferably between about 0.3-3.5%, and more preferably between about 0.3-0.9%. Proline is present in a range between about 4.1-14.4%, preferably between about 5.4-12.3%, and more preferably between about 7.1-10.4%. Serine is present in a range between about 1.7-5.4%, preferably between about 2.6-4.5%, and more preferably between about 3.2-3.9%. Threonine is present in a range between about 1.3-4.2%, preferably between about 2.1-3.5%, and more preferably between about 2.5-3.1%. Tryptophan is present in a range between about 0.6-17.7%, preferably between about 0.7-15.4%, and more preferably between about 0.8-13.1%. Valine is present in a range between about 2.3-7.1%, preferably between about 3.5-5.9%, and more preferably between about 4.2-5.2%.

First coating 30, and/or first coating 70, in addition to the osmotic regulator, can also have one or more calcium compound, including, but not limited to, calcium nitrate. First coating 30, and/or first coating 70, can also contain a nitrate source, including, but not limited to, calcium nitrate or potassium nitrate. First coating 30, and/or first coating 70, can also contain other water soluble nitrogen. In a preferred embodiment, the calcium and nitrogen are present from dissolution of calcium nitrate, Ca(NO₃)₂. The amount of calcium and nitrogen present in first coating 30 is, in one embodiment, about 7% Ca+, 5% NO₃—N, and 4% NH₄—N. In another embodiment, the amount of nitrogen present in first coating 30 is about 1-10% nitrate nitrogen and 1-10% other water soluble nitrogen.

The osmotic regulator in first coating 30, and/or first coating 70, appears to enhance one or more of seed germination, seedling emergence, seedling vigor, percent ground coverage, and/or stand density. Also observed are faster germination times, higher resistance of the seed to environmental stress, increased speed to establishment, and/or growth rate. The enhancements are present even when the seed is subjected to abiotic stress conditions, reduced water availability, deficit irrigation techniques, sandy soils, high saline conditions (soil and/or irrigation water), fire-ravaged soils, or generally poor water and soil quality conditions, as well as under normal growing conditions.

The data in the Experimental section of this application provides additional test data for an amino acid coated seed for species of grass seed including, but not limited to, Seashore paspalum, Perennial ryegrass, Tall fescue, and Kentucky bluegrass. However, it is contemplated that similar enhancements would be provided by an amino acid coated seed of any variety, including, but not limited to, vegetable seed, corn seed, and wheat seed.

For example, seashore paspalum seed typically has some portion of seeds which are “low-germinating,” for which only about 60% of such seeds will normally germinate, and which also require good quality water (i.e., low-salinity) to germinate. However, using an amino acid coated seashore paspalum seed of the present disclosure, even if a “low germination” seed, can have a germination rate that is increased to about 80%, i.e., similar to the germination rate expected for “high germination” seashore paspalum seeds. The increase in germination rate can be found even when the amino acid coated seashore paspalum seed is exposed to poor quality (e.g., high-salinity) water.

It is believed that, upon exposure to water, seed 20 (or seed 60) uptakes the amino acid complex, and/or the calcium nitrate (or other calcium and nitrogen sources in first coating 30 or 70) for the beneficial effects on seed germination and development to occur.

One potential mechanism by which the osmotic regulator coating may enhance seed germination and development is that the osmotic regulator coating, once activated by water, create a more pliant seed coat; i.e., outer layer 22 of seed 20 (or outer layer 62 of seed 60 in FIG. 2) on which first coating 30 (and/or first coating 70) is disposed.

Second coating 40 can be made of a material including, but not limited to, diatomaceous earth (DE), limestone, and/or a binder. Diatomaceous earth is a naturally occurring, soft, siliceous sedimentary rock, which can be crumbled into a fine powder particle sizes ranging from 3 μm to 1 mm, and which contains 70 to 95% silica, 2 to 4% alumina and 0.5 to 2% iron oxide. Binders that can be used in second coating 40 include, but are not limited to, polyvinyl alcohol (PVA), polymers and copolymers of polyvinyl acetate, vinylidene chloride, methyl cellulose, acrylic, cellulose, polyvinylpyrrolidone, polysaccharide, or any combinations thereof.

Advantageously, second coating 40, and the binders and/or diatomaceous earth and/or lime/limestone, provide a mechanism of keeping the osmotic regulator coating in contact with the seed, and maintaining such for prolonged period of time once the seed has been planted and/or the coating activated.

It should be noted, that the components of second coating 40 can optionally be included in the osmotic regulator coating. Likewise, components of the osmotic regulator coating can also be included in second coating 40.

The osmotic regulator coating, alone or in combination with second coating 40, creates a barrier protecting the seed for the abiotic stressors in the environment. Such a barrier may prevent, for example, sodium from dehydrating the seed and prevents an osmotic adjustment, i.e. water leaving the seed to balance the effects of the salt.

Osmotic regulator coated seed 10 (or osmotic regulator coated seed 50) can be made by the following method, which is by coating the seed with a treatment using a seed coater utilizing centrifugal forces. For example, a spinning drum with positive air pressure from below the drum is used to push seeds to an outer wall of the drum. A spinning dish centrally located in the drum, then distributes the treatment, i.e. first coating 30 and second coating 40, evenly onto the seeds. An example of such a seed coater is the RP14DB rotostat seed coater (BraceWorks Automation and Electric, Lloydminster, Saskatchewan, Canada).

In one embodiment, all treatments, i.e., first coating 30 and second coating 40, are coated onto seed 20 based on percentage of total seed weight. This allows treatment to work regardless of total seed volume.

In certain embodiments, first coating 30 has an amino acid complex (AAC) at 6% onto a bare seed. First coating 30 is coated with 6% weight of product to total seed weight (w/w) of AAC and 19% w/w of an 8% solution of polyvinyl alcohol (PVA) (Selvol 205). Next, 17% w/w activated carbon is added to the seed mixture. Second coating 40, at rate of 10% w/w of PVA is added to bare seed 20 and first coating 30 followed by an addition of diatomaceous earth until the mixture was dry.

Preferably, the AAC in first coating 30 is present between about 0.5-20% w/w of the seed, more preferably between about 3-15%, and most preferably, between about 5-15%. More preferably, AAC is present at about 6% w/w, or at about 12% w/w, of the total seed weight.

In embodiments where the osmotic regulator is an amino acid complex, the dry amino acid coated seed 10 disclosed herein does not have its amino acid complex activated (i.e., taken up or imbibed by the seed through its seed coat, also called outer layer 22 herein) to any appreciable degree. The amino acid coated seed may be stored and transported so as to avoid or minimize contact of amino acid coated seed 10 with water or with moisture in the air. However, once the amino acid coated seed of the present disclosure is placed in the soil and exposed to water, the amino acid complex in first coating 30 is activated and is taken up or imbibed by the seed to provide the enhanced effects on seed germination and development described in this application.

Thus there can be little or no activation of the amino acid complex prior to planting and watering during storage or transport. The amino acid is an osmotic regulator, meaning it is used to help the plant balance its internal water content. The amino acids and calcium nitrate work together to provide an optimum growing environment under stressful conditions. Under saline conditions, Ca⁺⁺ can control ion transport and limit or reduce levels of sodium within the cell membrane. This can protect the cell from leakage and allows basic cell functions to continue despite saline conditions outside of the microenvironment surrounding the seed. By lowering the osmotic potential during the seed coating process, water and nutrients can flow into the seed contrary to what would be expected under saline conditions. The addition of amino acids can help the seedling avoid drought, saline and oxidative stress. The amino acids can also soften the seed coat and make it easier for the seed to emerge in less than optimum environments.

First coating 30 and/or second coating 40 can also contain activated carbon. Activated carbon can be used as a drying agent. Activated carbon can also remove unwanted impurities from irrigation water or the surrounding air.

Advantageously, the coated seeds of the present disclosure can be planted earlier and thereby extend the growing season, due to their enhanced germination capabilities.

### EXPERIMENTAL

Testing took place at four geographic locations during 2013. Grass species included in the analysis were: seashore paspalum, perennial ryegrass, tall fescue, and Kentucky bluegrass. Treatments varied slightly from study to study, encompassing water repellant and non-repellent soils, deficit irrigation, varying degrees of salinity stress, nutrient management, and seed coating thickness. Basic turf grass measurements included: germination counts, percent cover, seedling vigor, days to reach 3 inch height, and oven dry leaf clippings. The AAC used for these studies was ASET-4000™ (Aquatrols® Corp., Paulsboro, N.J., U.S.A.). A detailed description of the methodologies used at each location and corresponding results is provided herein.

Site 1: Las Cruces, N. Mex.

Three studies were conducted at this site including all three scales of assessment: agar, greenhouse, and field trial.

The agar trial was established by seeding seashore paspalum in an agar medium and growth chamber (See AOSA Method, 2009). Seed treatments were arranged as a 2×3 factorial, where treatments consisted of: a) a control (no seed coating) and seeds coated with ASET-4000 at the 6% rate, and b) saline water amendments at 0.6 ds m⁻¹ (tap water), 10 ds m⁻¹, or 20 ds m⁻¹. Seedling germination counts were collected twice weekly for 36 days.

Greenhouse studies were also conducted for perennial ryegrass and seashore paspalum. Seedling treatments consisted of a control (no seed coating) and seeds coated with ASET-4000 at the 6% rate. Treatments were completely randomized. Greenhouse pots were filled with soil and seeded with seashore paspalum on Feb. 14, 2013. Establishment (percent cover) was collected every two weeks, beginning Apr. 18, 2013.

Field trials were established using perennial ryegrass (“LS2300”), Kentucky bluegrass, and tall fescue. Plots were arranged on a sandy loam soil. Treatment levels consisted of a) control (no seed coating) and a seed coating at the 6% (perennial ryegrass and Kentucky bluegrass) or 12% (tall fescue) ASET-4000 rate, and b) irrigation at 50% replacement evapotranspiration or 100% replacement evapotranspiration. Plots were seeded in September 2013 and percent cover was collected visually.

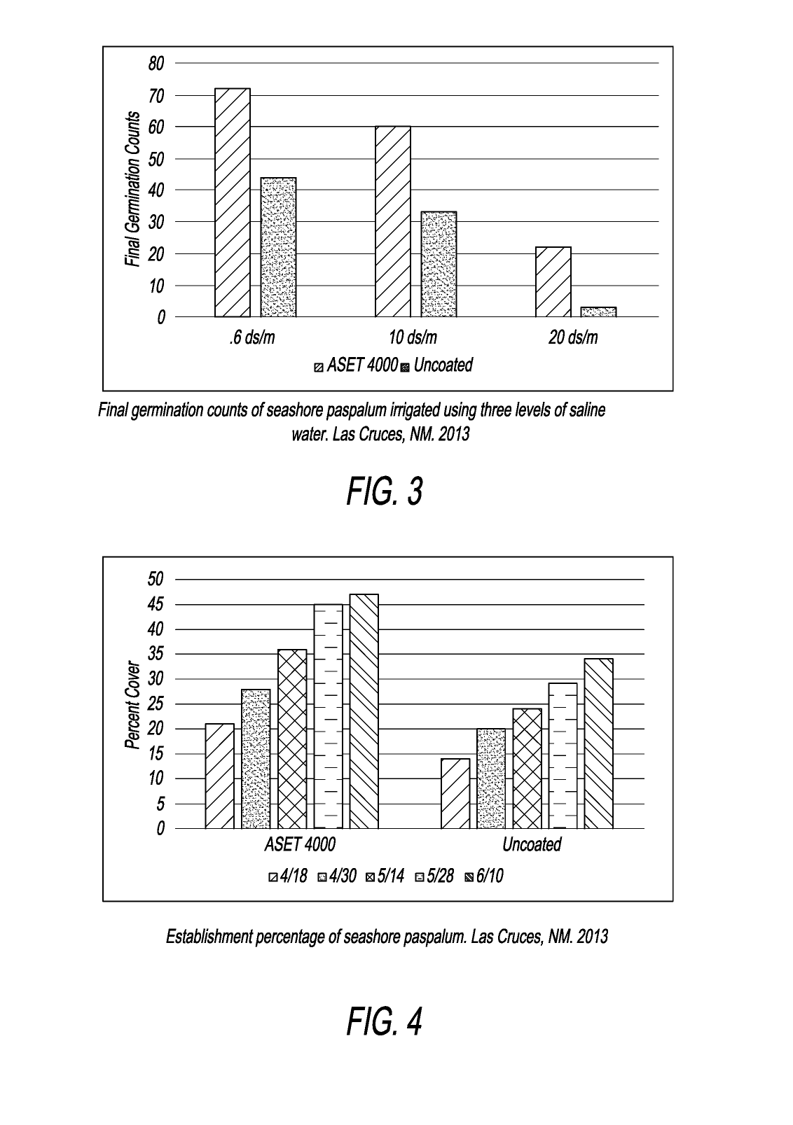

A single AGAR gel trial was conducted to assess germination of seashore paspalum under varying levels of salinity stress, with and without an ASET-4000 seed coating at 6% (FIG. 3, Table 1). ASET-4000 treated seeds germinated at a rate 1.6, 1.8 and 7.3 times greater than the control at salt concentrations of 0.6, 10, and 20 dsm⁻¹, respectively. It should also be noted that germination of ASET-4000 treated seeds at the 10 ds m⁻¹ salinity concentration exceeded germination counts of the control at the 0.6 ds m⁻¹ and 10 ds m⁻¹ salt concentrations. Germination at 20 ds m⁻¹ was substantially impacted despite ASET-4000 treatments; however, seeds receiving ASET-4000 germinated at 7 times the rate of the control group.

FIG. 3 is a chart of showing final germination counts of seashore paspalum irrigated using three levels of saline water at Las Cruces, N. Mex. in 2013.

Table 1 is a tabulation of the data shown in FIG. 3:

| Treatments | 0.6 ds/m | 10 ds/m | 20 ds/m |
|---|---|---|---|
| ASET 4000 | 72a | 60a | 22a |
| Uncoated | 44b | 33b | 3b |

NS: P > 0.05

A greenhouse trial was conducted. Perennial ryegrass and seashore paspalum were evaluated to assess differences in percent cover between seeds treated with the ASET-4000 seed coating and a control group receiving no seed treatment. For seashore paspalum and perennial ryegrass, the earliest observations (Apr. 18, 2013) indicate that ASET-4000 significantly increases percent cover (FIGS. 4 & 5; Tables 2 & 3). Beyond the initial rating date, seashore paspalum continued to show higher percent cover compared to the control group. Perennial ryegrass results indicate a significantly higher percent cover compared to the control group; however, differences were not significant after the Apr. 18, 2013, observation date.

FIG. 4 is a chart showing establishment percentage of seashore paspalum at Las Cruces, N. Mex. in 2013.

Table 2 is a tabulation of the data shown in FIG. 4:

| Treatments | 18-Apr | 30-Apr | 14-May | 28-May | 10-Jun |
|---|---|---|---|---|---|
| ASET 4000 | 19abc | 20bc | 20ab | 24ab | 24ab |
| Uncoated | 14d | 16c | 16b | 18b | 18b |

NS: P > 0.05

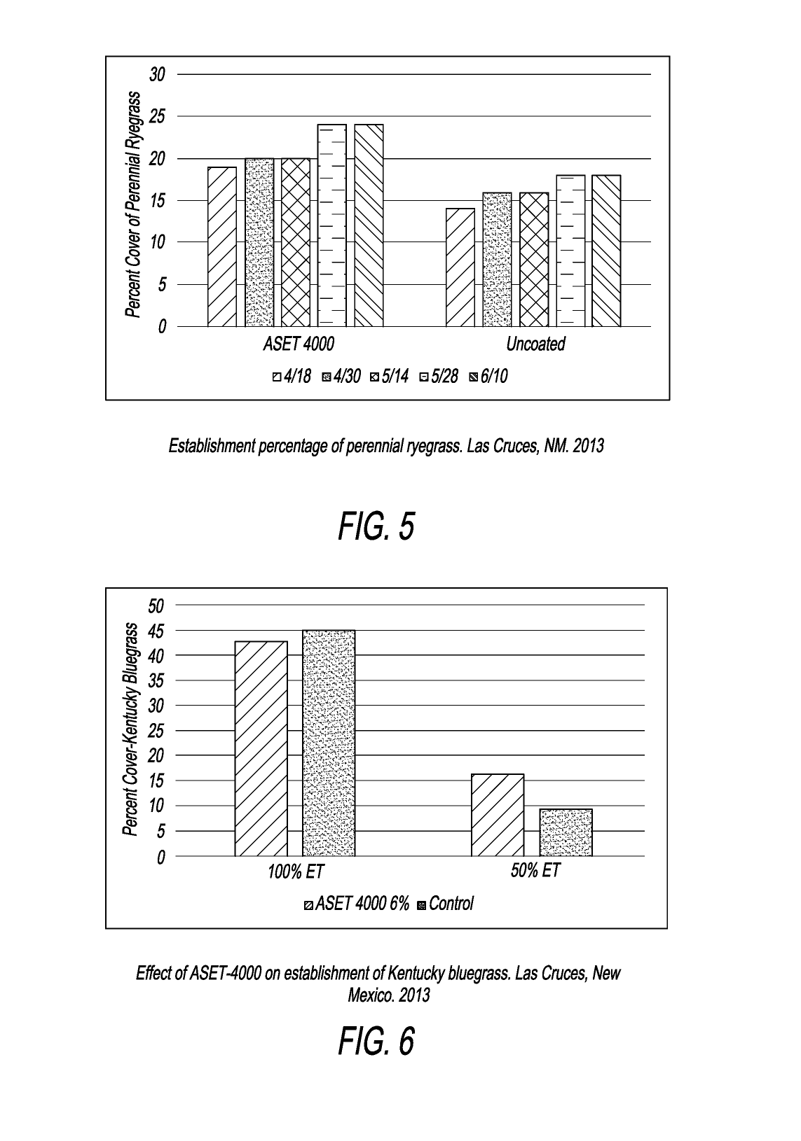

FIG. 5 is a chart showing establishment percentage of perennial ryegrass at Las Cruces, N. Mex. in 2013.

Table 3 is a tabulation of the data shown in FIG. 5:

| Treatments | 18-Apr | 30-Apr | 14-May | 28-May | 10-Jun |
|---|---|---|---|---|---|
| ASET 4000 | 21ab | 28ab | 36ab | 45ab | 47ab |
| Uncoated | 14c | 20c | 24c | 29d | 34d |

NS: P > 0.05

FIG. 6 is a chart showing the effect of ASET-4000 on establishment of Kentucky bluegrass at Las Cruces, N. Mex. in 2013.

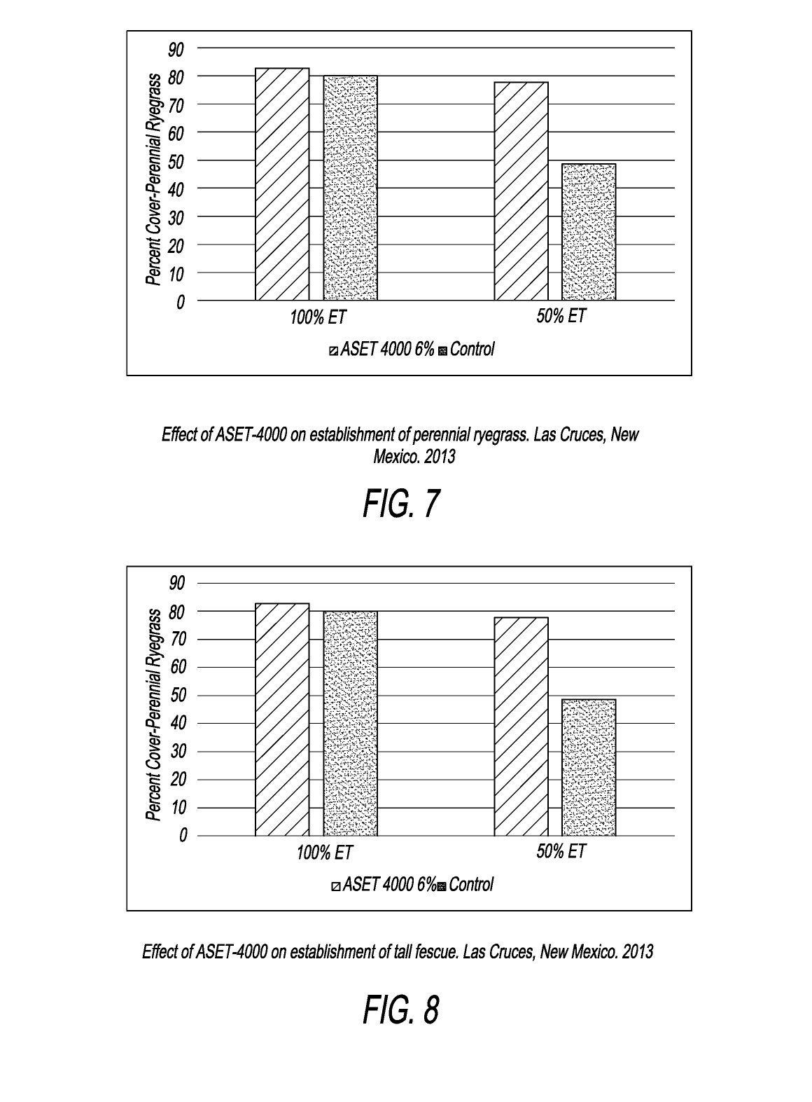

FIG. 7 is a chart showing the effect of ASET-4000 on establishment of perennial ryegrass at Las Cruces, N. Mex. in 2013.

FIG. 8 is a chart showing the effect of ASET-4000 on establishment of tall fescue at Las Cruces, N. Mex. in 2013.

Three turf grass varieties were evaluated based on seed coating (with and without ASET-4000) and irrigation regime (100% ET or 50% ET). In all three turf grass varieties, coated seeds yielded significantly higher percent cover compared to the uncoated control (FIGS. 6-8). No significant benefit associated with seed coating was observed when irrigation needs were met. It should also be noted that while a reduction in percent cover was observed for each variety under deficit irrigation, perennial ryegrass establishment was least affected when seed coatings were applied. Tall fescue also exhibited a higher degree of drought tolerance when seed coatings were applied. Kentucky bluegrass was most drought sensitive, even in the presence of a seed coating.

Site 2: Berks, Pa.

Two greenhouse studies were conducted evaluating: a) Kentucky bluegrass performance under deficit irrigation with and without an ASET-4000 seed coating at the 6% rate and b) perennial ryegrass performance using three different ASET-4000 seed coating rates (0, 6, or 12%) with and without fertilizer amendments. In each case, greenhouse pots were filled with a silt loam soil and seeded at 3 lbs. M⁻¹ and 10 lbs. M⁻¹ for the Kentucky bluegrass and Perennial Ryegrass, respectively. Seeds were placed on the soil, pressed, covered with more of the same soil, and then immediately received 0.25 inches of water. For the Kentucky bluegrass trial, deficit irrigation was maintained at 0.75 inches of water per week. For the perennial ryegrass trial and fertilizer treatments were applied as calcium nitrate at a rate similar to the amount supplied via ASET-4000 or no fertilizer. It was found that the amino acids alone provided enhanced seedling benefits. Additional calcium nitrate had no negative effects.

Ground truth consisted of seedling emergence; percent cover, seedling vigor, days to 3 inch height, and over-dry leaf clippings. Seedling emergence was conducted by counting shoots, until 20 shoots were evident. Thereafter, percent cover was used to evaluate emergence and rated visually on a scale of 0-100%. Seedling vigor was assess as turf quality using a 1-9 visual rating where 1=no emergence and 10=healthy turf. Oven dry leaf clipping weights and days to 3 inch height were assessed for the perennial ryegrass study only. Days to 3 in height were determined as the number of days for the potted area to reach 3 inches. Measurements were collected daily for the first 7 days after seeding and then weekly thereafter.

At The Pennsylvania State University, two greenhouse trials were evaluated to test: a) Kentucky bluegrass performance under deficit irrigation and with/without an ASET-4000 seed coating, and b) perennial ryegrass performance with and without fertilizer using ASET-4000 seed treatments at the 0, 6, and 12% rate.

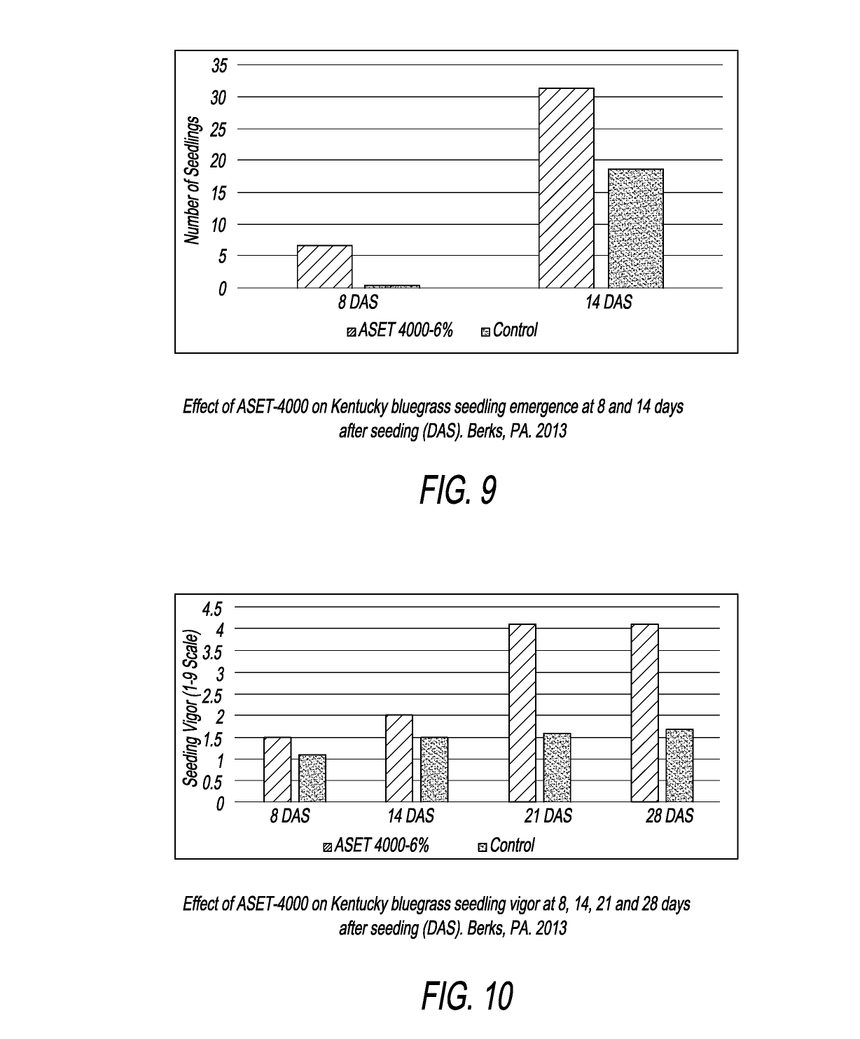

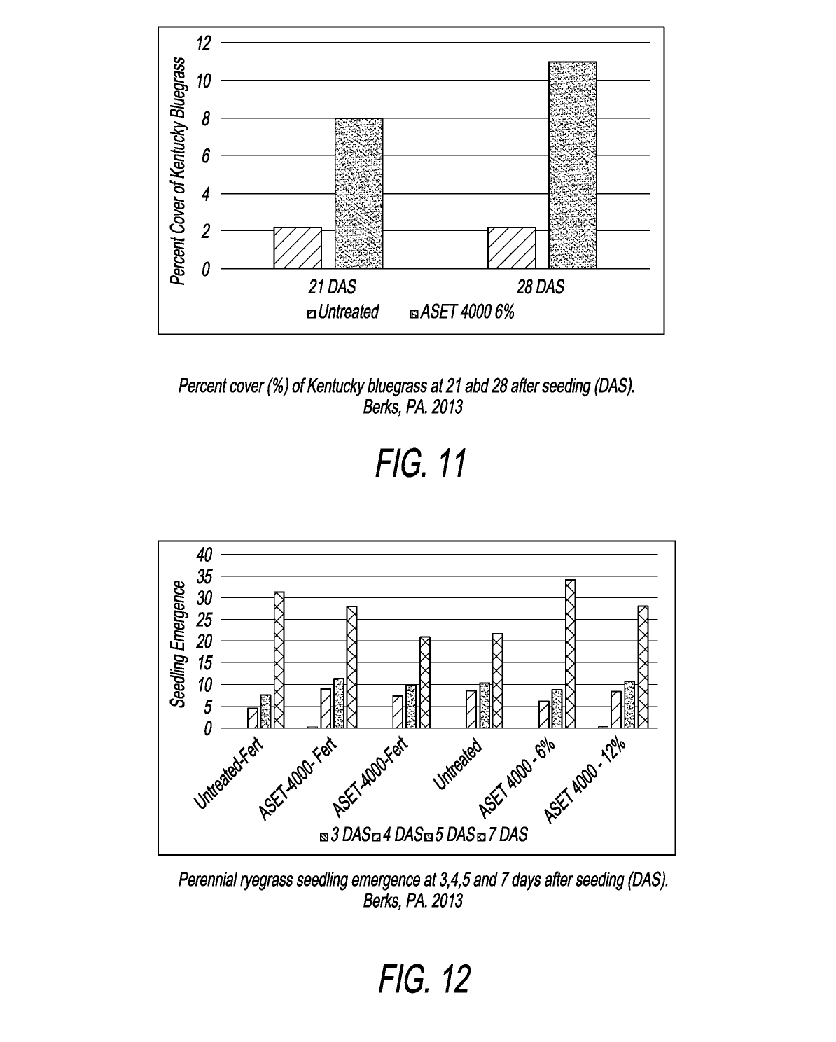

In the Kentucky bluegrass trial, significant improvements in emergence, seedling vigor, and percent cover were observed for seeds receiving the ASET-4000 seed coating. Emergence of treated seeds was observed as early as 8 days after seeding and by 14 days after seeding ASET-4000 treated seedling emergence counts increased five-fold and were significantly greater than the control group (FIG. 9, Table 4). Seedling vigor for ASET-4000 treated seeds was significantly higher than the control group and continued to increase throughout the measurement period (8 days after seeding through 28 days after seeding) (FIG. 10 and Table 5). Control group seedling ratings plateaued at 14 days after seeding with a rating of 1.5-1.7, compared to the ASET-4000 treated seeds, having a final seedling vigor rating of 4.1. Percent cover was 4 and 5 times greater from ASET-4000 treated seeds compared to the control ranging from 8 to 11% (FIG. 11 and Table 6).

FIG. 9 is a chart showing Effect of ASET-4000 on Kentucky bluegrass seedling emergence at 8 and 14 days after seeding (DAS) at Berks, Pa., in 2013.

Table 4 is a tabulation of the data shown in FIG. 9:

| Treatments | 8 DAS | 14 DAS |
|---|---|---|
| ASET 4000 | 6.6a | 31.4c |
| Control | 0.4b | 18.6d |
| LSD P = 0.05 | 3.98 | 6.14 |

FIG. 10 is a chart showing the effect of ASET-4000 on Kentucky bluegrass seedling vigor at 8, 14, 21 and 28 days after seeding at Berks, Pa., in 2013.

Table 5 is a tabulation of the data shown in FIG. 10:

| Treatments | 8 DAS | 14 DAS | 21 DAS | 28 DAS |
|---|---|---|---|---|
| ASET 4000-6% | 1.5b | 2a | 4.1ab | 4.1a |
| Control | 1.1c | 1.5b | 1.6d | 1.7c |
| LSD P = 0.05 | 0.31 | 0.32 | 0.51 | 0.56 |

FIG. 11 is a chart showing percent cover (%) of Kentucky bluegrass at 21 and 28 days after seeding at Berks, Pa., in 2013.

Table 6 is a tabulation of the data shown in FIG. 11:

| Treatments | 21 DAS | 28 DAS |
|---|---|---|
| Untreated | 2.2b | 2.2c |
| ASET 4000 6% | 8c | 11d |
| LSD = P = 0.05 | 2.87 | 4.21 |

FIG. 12 is a chart showing perennial ryegrass seedling emergence at 3, 4, 5 and 7 days after seeding at Berks, Pa., in 2013.

Table 7 is a tabulation of the data shown in FIG. 12.

| Seed Coating | Fertility | 3 DAS | 4 DAS | 5 DAS | 7 DAS |
|---|---|---|---|---|---|
| Untreated | Fertilized | 0.00 | 4.60 | 7.60 | 31.4a |
| ASET 4000 - 6% | Fertilized | 0.20 | 9.00 | 11.40 | 28ab |
| ASET 4000 - 12% | Fertilized | 0.00 | 7.40 | 9.80 | 21c |
| Untreated | No Fertilizer | 0.00 | 8.60 | 10.40 | 21.8bc |
| ASET 4000 - 6% | No Fertilizer | 0.00 | 6.20 | 8.80 | 34.2a |
| ASET 4000 - 12% | No Fertilizer | 0.40 | 8.40 | 10.80 | 28ab |
| LSD P = 0.05 | | NS | NS | NS | 6.57 |

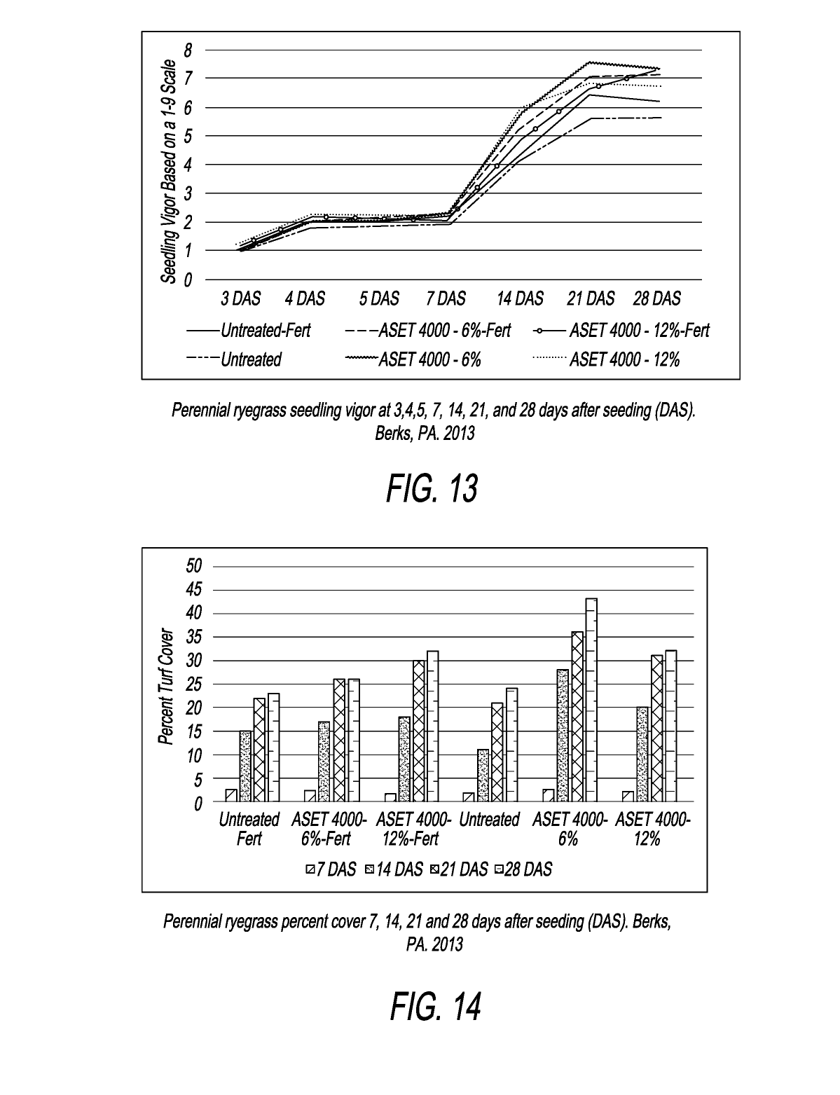

Differences in seedling vigor were observed at 14, 21 and 28 days after seeding, with seeds receiving ASET-4000 at the 6% rate without supplemental fertilizer showing the greatest degree of vigor (FIG. 13 and Table 8). Among fertilized treatments, ASET-4000 at the 6% rate exhibited significantly greater seedling vigor compared to the uncoated control. Comparing the ASET-4000 coatings at 6% and 12%, no benefits from the 12% treatment were observed. Among the unfertilized treatments, seeds receiving the ASET-4000 coating received significantly higher seedling vigor ratings compared to the control. In only one instance (14 days after seeding) was there a benefit to the ASET-4000 coating at the 12% rate. Comparing the unfertilized ASET-4000 seed coating at 6% to the uncoated and fertilized control group, supplemental fertilizer does not appear to benefit seedling vigor where ASET-4000 at the 6% rate has been applied.

FIG. 13 is a chart showing perennial ryegrass seedling vigor at 3, 4, 5, 7, 14, 21 and 28 days after seeding at Berks, Pa., in 2013.

Table 8 is a tabulation of the data shown in FIG. 13.

| Treatments | Fertility | 3 DAS | 4 DAS | 5 DAS | 7 DAS | 14 DAS | 21 DAS | 28 DAS |
|---|---|---|---|---|---|---|---|---|
| Untreated | Fertilized | 1 | 2 | 2.1 | 2.2 | 4.3c | 6.4c | 6.2c |
| ASET 4000-6% | Fertilized | 1.2 | 2.2 | 2.2 | 2.2 | 5.2b | 7ab | 7.1ab |
| ASET 4000-12% | Fertilized | 1 | 2.2 | 2.2 | 2 | 4.8b | 6.6bc | 7.3a |
| Untreated | No Fertilizer | 1 | 1.8 | 1.8 | 1.9 | 4.1d | 5.6d | 5.6d |
| ASET 4000-6% | No Fertilizer | 1 | 2 | 2 | 2.3 | 5.7a | 7.5a | 7.3a |
| ASET 4000-12% | No Fertilizer | 1.2 | 2.2 | 2.2 | 2.2 | 5.9bc | 6.8bc | 6.7b |
| LSD P = 0.05 | | NS | NS | NS | NS | 0.452 | 0.528 | 0.405 |

Differences in percent cover were most evident at 14, 21, and 28 days after seeding. Unfertilized seeds receiving ASET-4000 at the 6% rate showed the greatest degree of cover (FIG. 14 and Table 9). Among the fertilized treatments, there was a trend toward higher percent cover with ASET-4000 (6 or 12% rate); however, no significant differences were observed between treatments (including the control). Among the unfertilized treatments, ASET-4000 at the 12% rate showed significantly greater coverage on day 14 only. Subsequent observations exhibited significantly higher percent cover for pots receiving the ASET-4000 coating at 6%. Moreover, the unfertilized ASET-4000 coating at 6% showed significantly higher percent coverage compared to uncoated, fertilized control and the fertilized, ASET-4000 at 6% treatment. Results suggest that supplemental fertilizer is not necessary when ASET-4000 at the 6% rating has been applied.

FIG. 14 is a chart showing perennial ryegrass percent cover 7, 14, 21 and 28 days after seeding at Berks, Pa., in 2013.

Table 9 is a tabulation of the data shown in FIG. 14.

| Treatments | Fertility | 7 DAS | 14 DAS | 21 DAS | 28 DAS |
|---|---|---|---|---|---|
| Untreated | Fertilized | 2.6 | 15bc | 22cd | 23b |
| ASET 4000 - 6% | Fertilized | 2.4 | 17b | 26bcd | 26b |
| ASET 4000 - 12% | Fertilized | 1.6 | 18b | 30abc | 32ab |
| Untreated | No Fertilizer | 1.8 | 11c | 21d | 24b |
| ASET 4000 - 6% | No Fertilizer | 2.6 | 28a | 36a | 43a |
| ASET 4000 - 12% | No Fertilizer | 2 | 20b | 31ab | 32ab |
| LSD P = 0.05NS | | | 5.24 | 8.92 | 11.34 |

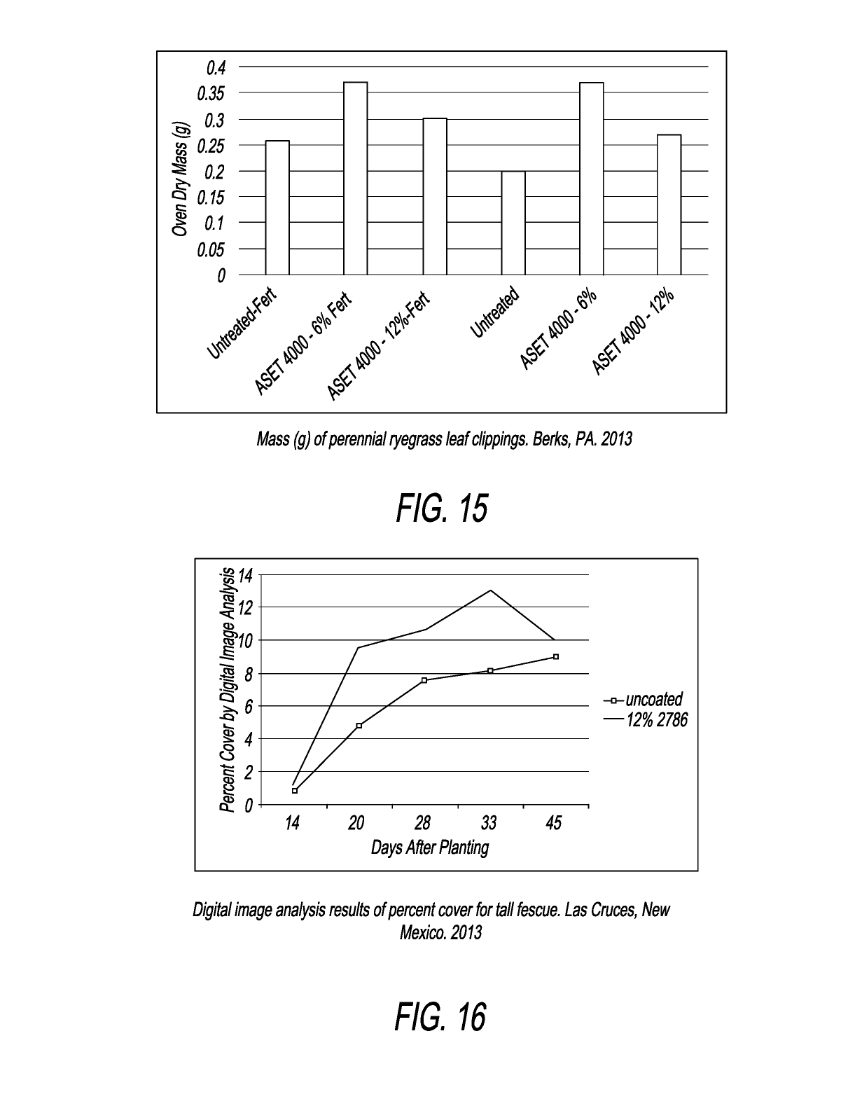

Fertility treatments improved growth rate slightly for the uncoated seeds; however, seeds receiving ASET-4000 at the 6 or 12% wt:wt reached the 3 inches height 3 and 4 days earlier than untreated seeds, without and with fertilizer, respectively (Table 10). No significant differences in rates of growth were observed between the 6 and 12% rates of ASET-4000 coatings. ASET-4000 seed coatings did not result in statistically higher oven dry leaf weights (FIG. 15); however, there was a trend toward higher oven dry leaf weights among seeds receiving ASET-4000. This trend indicates seeds coated with ASET-4000 had greater emergence, cover, and growth than untreated seeds under both fertilizer regimes.

FIG. 15 is a chart showing mass (g) of perennial ryegrass leaf clippings at Berks, Pa., in 2013.

Table 10 shows the number of days for perennial ryegrass to reach 3 inch height:

| Treatment | Fertility | Days to Reach 3″ Height |
|---|---|---|
| Untreated | Fertilized | 16.6a |
| ASET 4000 - 6% | Fertilized | 13b |
| ASET 4000 - 12% | Fertilized | 13b |
| Untreated | No Fertilizer | 16b |
| ASET 4000 - 6% | No Fertilizer | 12.8b |
| ASET 4000 - 12% | No Fertilizer | 12.8a |
| LSD P = 0.05 | | 0.78 |

Site 3: Lubbock, Tex.

A single field trial was conducted to evaluate tall fescue response to a seed coat treatment in a nutrient poor and saline rich environment. Plots (12 ft²) were established on a sandy loam soil in a randomized complete block design, having two treatments replicated three times each. Treatments consisted of a control (no seed coating) and seeds coated with ASET-4000 at the 12% rate. Plots were fertilized with 21-4-7 to provide 1 lb. N/1000 ft². Irrigation was provided 3 times a day at 10 minute increments. After germination, irrigation was provided for only 30 minutes in the morning. At this location, water quality is very poor. Irrigation water consists of: high salts (electrical conductivity >1.87 ds m⁻¹), high bicarbonate (339 ppm), high total soluble salts (1199 ppm) and high pH (7.70). Percent cover was evaluated using digital image analysis on a weekly basis.

Tall fescue was evaluated in the field on a sandy loam soil, with treatments consisting of coated (ASET-4000 12%, shown in FIG. 16 as “12% 2786” that was its experimental number, ACA 2786) and an uncoated control. Treatment differences were not statistically significant at any time during this trial. There was a trend for the ASET-4000 coated seed to enhance germination and cover of tall fescue under these stressful conditions (FIG. 16). Poor water and soil quality, late planting and cool temperatures may have seriously affected tall fescue growth at this location.

FIG. 16 shows digital image analysis results of percent cover for tall fescue.

Site 4: Ft. Lauderdale, Fla.

Three greenhouse studies were conducted at this site using: perennial ryegrass and tall fescue. Two of the greenhouse studies were initiated in May 2013 to evaluate the effect of soil (water-repellent, non-repellent), and irrigation regime on seeds coated with one of three rates of ASET-4000 (0%, 6% or 12% rate). Studies were arranged as a completely randomized complete block, having 3 replications per treatment. Soils consisted of a naturally water repellant soil collected from a Florida citrus grove and a wettable sand. However, water drop penetration tests indicate the degree of water repellency to be slight in the citrus grove soil. Greenhouse pots were filled with the corresponding soils and seeded at a rate of 20 lbs. M⁻¹ or 3 lbs. M⁻¹ for the Perennial Ryegrass and Tall fescue, respectively. Water regimes include a high rate (0.25″ every day) and a low rate (0.25″ every other day). Seeds were not fertilized during this trial.

A third greenhouse study was conducted to evaluate perennial ryegrass seed response to level of ASET-4000 coating with and without supplemental fertilizer as calcium nitrate and soil type. Treatment levels consisted of an ASET-4000 seed coating at a rate of 0, 6, or 12% and receiving calcium nitrate at a rate in an amount similar to that supplied in the ASET-4000 treatment.

ASET-4000 contains 7% Ca+, 5% NO₃—N, and 4% water soluble NH₄—N. In 100 g of seed, there was the equivalent of 6 g of seed coating, therefore 0.42 g Ca⁺, 0.30 g NO₃—N, and 0.24 g NH₄—N. Fertilizer was mixed in a 2 L spray bottle with 2 gal of water per 1000 ft², with the final mixture containing 6.65 g CaCO₃ and 23.6 g NH₄SO₄. Treatments were arranged as a completely randomized block design and replicated 3 times. Greenhouse pots were filled with either sand or a silt loam soil and seeded with perennial ryegrass at 10 lbs. M⁻¹. Seeds were placed on the soil, pressed, covered with the same soil, and immediately watered with 0.25″ of water. Fertilizer was applied as a one-time application immediately after seeding. It was found that the amino acids alone provided enhanced seedling benefits. Additional calcium nitrate had no negative effects.

For all studies, percent cover was visually determined on a scale of 1-100%. Measurements were collected on May 13, May 14, May 16, May 21, May 28, and June 4.

Three greenhouse trials were conducted at this site, two of which evaluated turf grass response (perennial ryegrass or tall fescue) to irrigation level (high or low), soil (repellent or non-repellent), and ASET-4000 rate (0, 6, or 12%). The third trial evaluated perennial rye response to fertilizer (with and without calcium nitrate) and ASET-4000 rate (0, 6, or 12%).

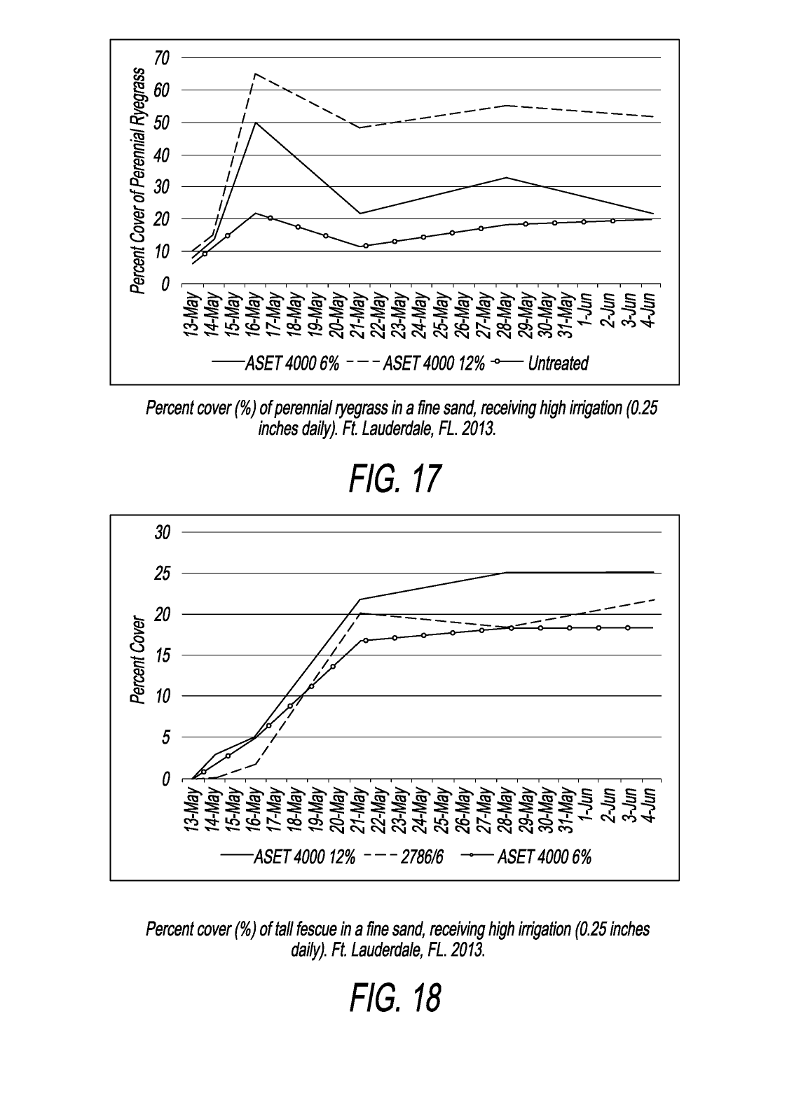

Irrigation trials were conducted. Grasses seeded to fine sand and receiving 0.25 inches of water daily (high irrigation rate) did not respond similarly to ASET-4000 seed treatments. Perennial ryegrass was quicker to emerge when treated with the ASET-4000 rate of 12%, compared to the control, and both rates exhibited significantly higher percent cover from May 16 through June 4 (Table 11, FIG. 17). Tall fescue was slower to respond to the seed treatment, showing significantly higher percent cover only at the end of the study (June 4) for plots receiving ASET-4000 at the 12% rate (Table 12, FIG. 18). The 6% rate actually exhibited lower percent cover compared to the control on May 14 and May 16. It should also be noted that the final percent cover ratings for tall fescue receiving the ASET-4000 coating at the 12% rate were substantially lower (percent cover=25%) compared to the perennial ryegrass results (percent cover=52%).

FIG. 17 is a chart showing percent cover (%) of perennial ryegrass in a fine sand, receiving high irrigation (0.25 inches daily) at Ft. Lauderdale, Fla., in 2013.

Table 11 is a tabulation of the data shown in FIG. 17:

| TREATMENT | 13-May | 14-May | 16-May | 21-May | 28-May | 4-Jun |
|---|---|---|---|---|---|---|
| ASET 4000 6% | 8ab | 13.3ab | 50c | 21.7de | 32.7bc | 21.7cd |
| ASET 4000 | 10a | 15a | 65a | 48.3a | 55a | 51.7a |
| 12% | | | | | | |
| Uncoated | 6.3b | 11.7ab | 21.7e | 11.7f | 18.3e | 20cd |
| Significance | *** | *** | *** | *** | *** | *** |

*** P = 0.001

FIG. 18 is a chart showing percent cover (%) of tall fescue in a fine sand, receiving high irrigation (0.25 inches daily) at Ft. Lauderdale, Fla., in 2013.

Table 12 is a tabulation of the data shown in FIG. 18:

| TREAMENT | 13-May | 14-May | 16-May | 21-May | 28-May | 4-Jun |
|---|---|---|---|---|---|---|
| ASET 4000 | 0 | 2.7a | 5.0a | 21.7 | 25a | 25a |
| 12% | | | | | | |
| ASET 4000 6% | 0 | 0b | 1.7bc | 20 | 18.3ab | 21.7ab |
| Control | 0 | 1.7ab | 5.0a | 16.7 | 18.3ab | 18.3b |
| Significance | ns | * | ** | ns | + | + |

*, **, +, and ns = P < 0.05, P < 0.01, P < 0.10, and P > 0.10

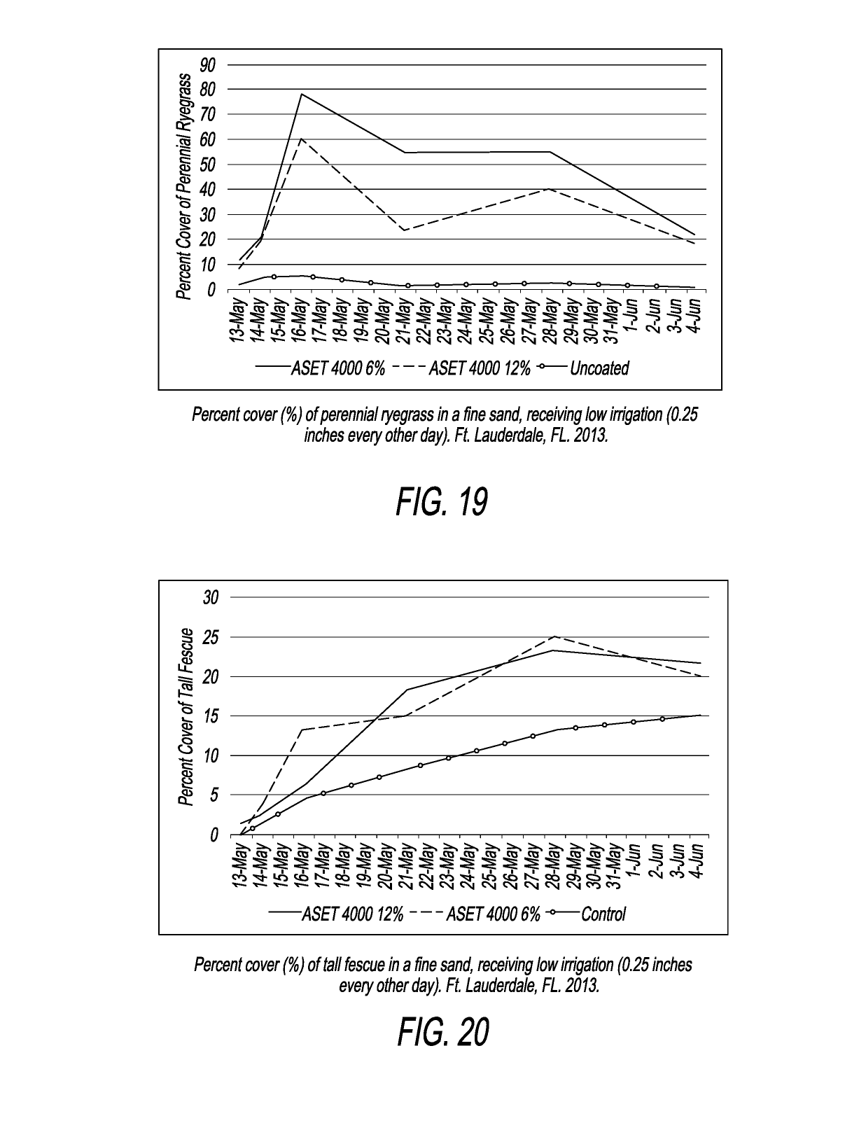

Grasses seeded in fine sand and receiving the low irrigation rate (0.25 inches every other day) each showed a significant improvement where the ASET-4000 seed coating was applied. For perennial ryegrass, percent cover ranged from 8-78%, peaking on May 16 and declining through June 4 (Table 13, FIG. 19). During peak performance, plots receiving the ASET-4000 coating at 12% and 6% exhibited 15 and 11 times greater cover compared to the control, respectively. Moreover, compared to the ASET-4000 coating at the 6% rate, plots receiving the 12% rate yielded significantly higher percent cover in 4 out of the 6 measurements. For tall fescue, percent cover generally increased from May 13 through June 4, ranging from 0-22%, with significantly higher cover relative to the control observed on May 16 and May 28 for the plots receiving the 6% rate of ASET-4000 (Table 14, FIG. 20). At the 12% rate of ASET-4000, tall fescue emerged more quickly, but exhibited significantly higher cover on only one other date, May 28, relative to the control.

FIG. 19 is a chart showing percent cover (%) of perennial ryegrass in a fine sand, receiving low irrigation (0.25 inches every other day) at Ft. Lauderdale, Fla., in 2013.

Table 13 is a tabulation of the data shown in FIG. 19:

| TREATMENT | 13-May | 14-May | 16-May | 21-May | 28-May | 4-Jun |
|---|---|---|---|---|---|---|
| ASET 4000 6% | 8.3a | 18.3b | 78.3a | 55a | 55a | 21.7a |
| ASET 4000 | 11.7a | 20a | 60b | 23.3c | 40b | 18.3abc |
| 12% | | | | | | |
| Uncoated | 1.7b | 4.2bc | 5.3ef | 1.3f | 2.3ef | 0.7d |
| Significance | *** | *** | *** | *** | *** | *** |

*** = P = <0.001

FIG. 20 is a chart showing percent cover (%) of tall fescue in a fine sand, receiving low irrigation (0.25 inches every other day) at Ft. Lauderdale, Fla., in 2013.

Table 14 is a tabulation of the data shown in FIG. 20:

| TREAMENT | 13-May | 14-May | 16-May | 21-May | 28-May | 4-Jun |
|---|---|---|---|---|---|---|
| ASET 4000 | 1.3a | 2.3ab | 6b | 18.3 | 23.3a | 21.7 |
| 12% | | | | | | |
| ASET 4000 6% | 0b | 3.7a | 13.3a | 15 | 25a | 20 |
| Control | 0b | 1.3ab | 4.3b | 8.3 | 13.3b | 15 |
| Significance | ** | * | * | ns | + | ns |

*, **, +, and ns = P < 0.05, P < 0.01, P < 0.10, and P > 0.10

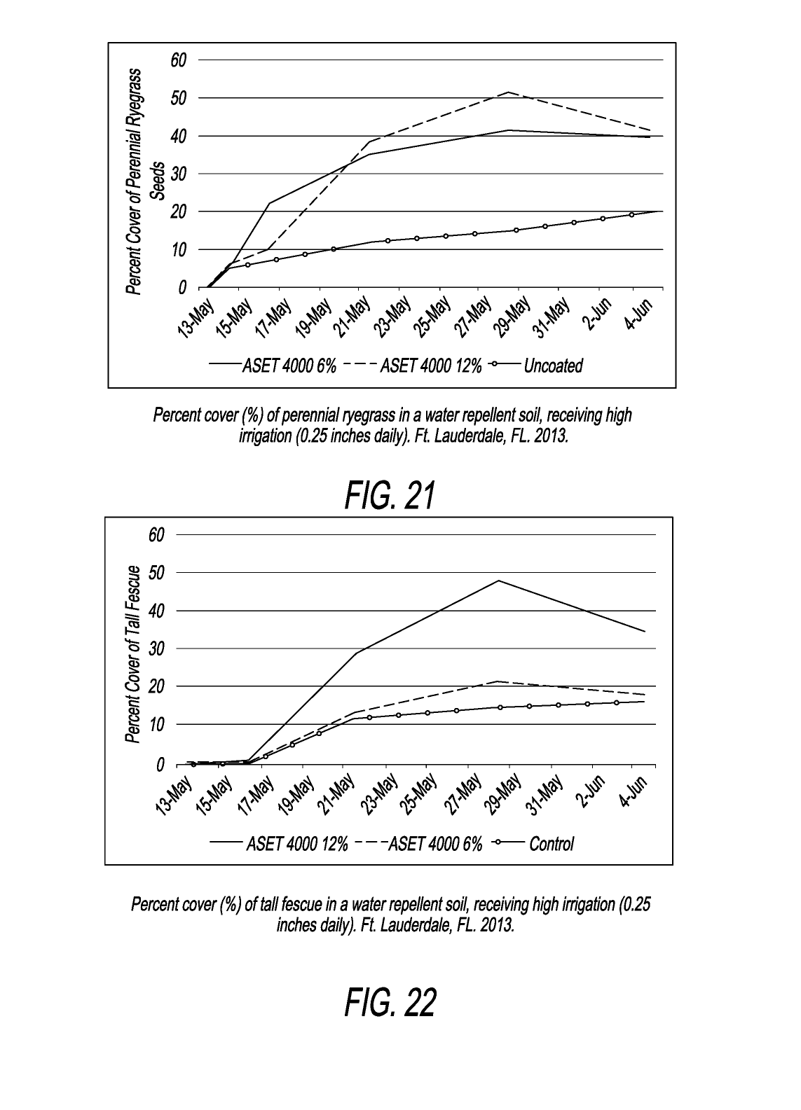

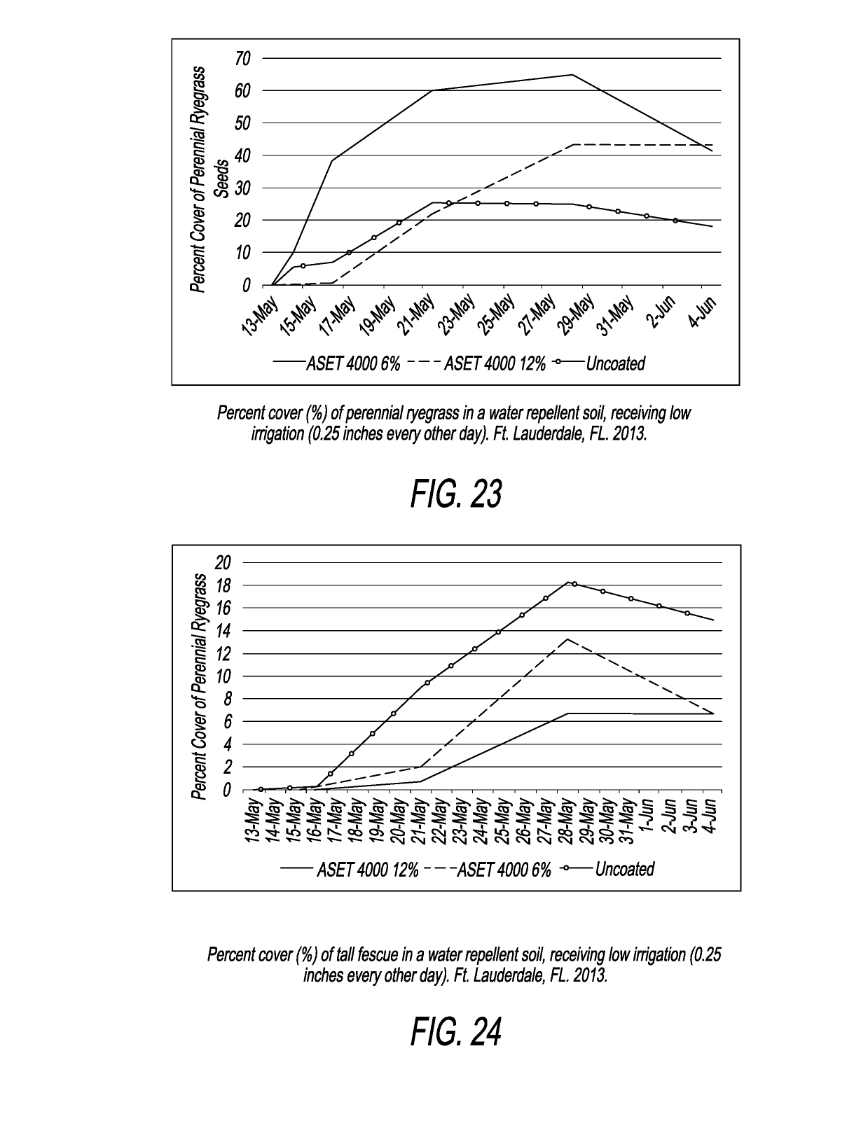

When grasses were seeded to a water repellent soil, and plots received the high irrigation rate (0.25 inches daily), significant differences in percent cover between ASET-4000 treated plots (6 and 12%) and the control were observed for both perennial ryegrass and tall fescue. Percent cover from perennial ryegrass ranged from 5-42%, with no significant differences in ASET-4000 rating observed in 4 out of 6 collection dates (Table 15, FIG. 21). Tall fescue plots were slower to emerge, with percent cover ranging from 0-48% (Table 16, FIG. 22). Differences in percent cover relative to the control were not observed until May 21, and no statistically significant benefit to the ASET-4000 coating at 6% was observed.

FIG. 21 is a chart showing percent cover (%) of perennial ryegrass in a water repellent soil, receiving high irrigation (0.25 inches daily) at Ft. Lauderdale, Fla., in 2013.

Table 15 is a tabulation of the data shown in FIG. 21:

| TREATMENT | 13-May | 14-May | 16-May | 21-May | 28-May | 4-Jun |
|---|---|---|---|---|---|---|
| ASET 4000 6% | 0 | 4.7ab | 21.7b | 35bcd | 41.7cde | 40ab |
| ASET 4000 | 0 | 5.7a | 10c | 38.3bc | 51.7abc | 41.7a |
| 12% | | | | | | |
| Uncoated | 0 | 4.7ab | 6.7cd | 11.7g | 15hi | 20cd |
| Significance | ns | *** | *** | *** | *** | *** |

*** = P = <0.001

FIG. 22 is a chart showing percent cover (%) of tall fescue in a water repellent soil, receiving high irrigation (0.25 inches daily) at Ft. Lauderdale, Fla., in 2013.

Table 16 is a tabulation of the data shown in FIG. 22:

| TREAMENT | 13-May | 14-May | 16-May | 21-May | 28-May | 4-Jun |
|---|---|---|---|---|---|---|
| ASET 4000 | 0 | 0 | 0.83a | 28.3a | 48.3a | 35a |
| 12% | | | | | | |
| ASET 4000 6% | 0 | 0 | 0.17b | 13.3c | 21.7bc | 18.3b |
| Control | 0 | 0 | 0.5ab | 11.7c | 15c | 16.7b |
| Significance | ns | ns | * | ** | *** | *** |

*, **, +, and ns = P < 0.05, P < 0.01, P < 0.10, and P > 0.10

When grasses were seeded to a water repellent soil, and plots received the low irrigation rate (0.25 inches every other day) only the perennial ryegrass exhibited a significant and positive response to ASET-4000 coatings (Table 17 & 18 and FIGS. 22 & 24). Ryegrass cover ranged from 0-65%, peaking from May 16 to May 28, and then declining. The ASET-4000 coating at the 6% resulted in consistently and significantly higher percent cover compared to the 12% rating throughout the study. In fact, the 12% ASET-4000 rating did not yield statistically higher percent cover relative to the control until the final two observation dates.

FIG. 22 is a chart showing percent cover (%) of perennial ryegrass in a water repellent soil, receiving low irrigation (0.25 inches every other day) at Ft. Lauderdale, Fla., in 2013.

Table 17 is a tabulation of the data shown in FIG. 22:

| Treatment | 13-May | 14-May | 16-May | 21-May | 28-May | 4-Jun |
|---|---|---|---|---|---|---|
| ASET 4000 6% | 0 | 9.7a | 38.3a | 60a | 65a | 41.7a |
| ASET 4000 | 0 | 0d | 0.5e | 21.7cde | 43.3bc | 43.3a |
| 12% | | | | | | |
| Uncoated | 0 | 5.3b | 7de | 25cd | 25de | 18.3bc |
| Significance | ns | *** | *** | *** | *** | *** |

*** = P < 0.001.

FIG. 24 is a chart showing percent cover (%) of tall fescue in a water repellent soil, receiving low irrigation (0.25 inches every other day) at Ft. Lauderdale, Fla., in 2013.

Table 18 is a tabulation of the data shown in FIG. 24:

| TREAMENTT | 13-May | 14-May | 16-May | 21-May | 28-May | 4-Jun |
|---|---|---|---|---|---|---|
| ASET 4000 | 0 | 0 | 0 | 0.7b | 6.7b | 6.7b |
| 12% | | | | | | |
| ASET 4000 6% | 0 | 0 | 0 | 2ab | 13.3a | 6.7b |
| Control | 0 | 0.03 | 0.3 | 9a | 18.3a | 15a |
| Significance | ns | ns | ns | + | ** | *** |

*, **, +, and ns = P < 0.05, P < 0.01, P < 0.10, and P > 0.10

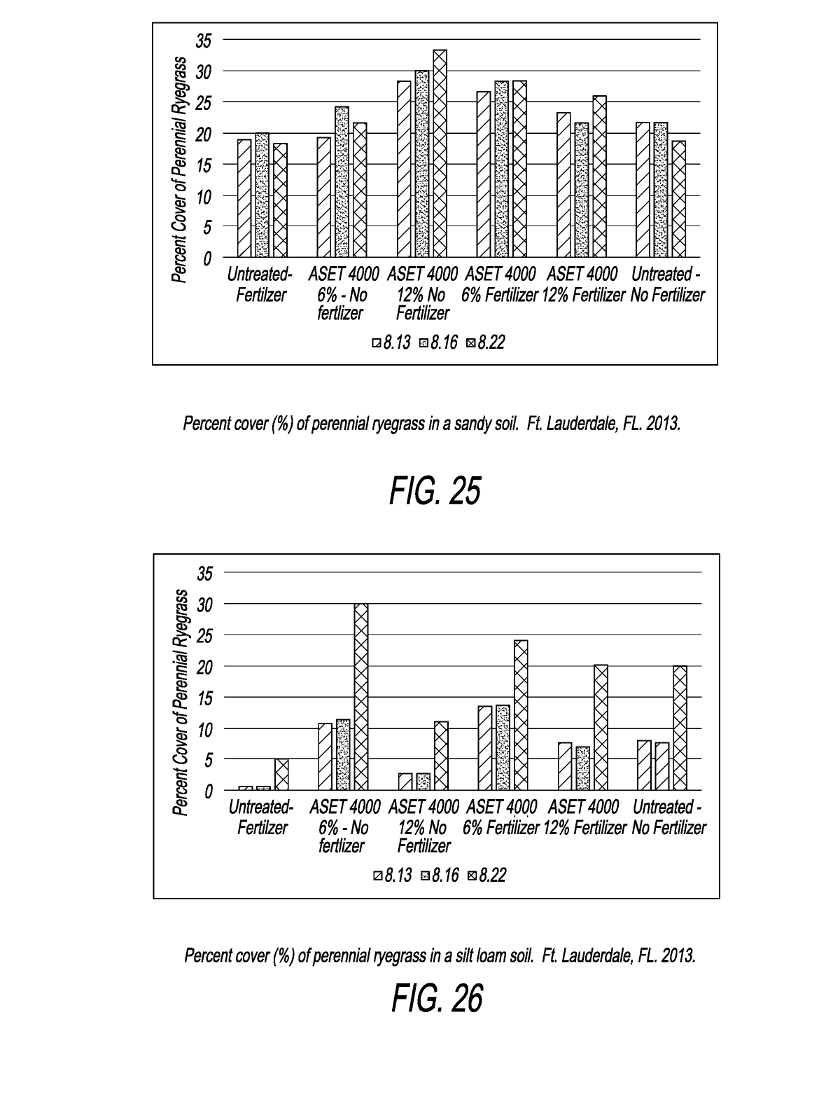

Fertility trials were conducted. Perennial ryegrass response to soil and fertility, with and without fertilizer amendments did not exhibit any significant differences in cover until the third and final rating date. On August 22, in the sandy soil the ASET-4000 12% coating without fertilizer exhibited substantially higher cover than any other treatment and was significantly higher than controls (uncoated seeds with and without fertilizer) and the ASET-4000 6% rate without fertilizer (Table 19, FIG. 25). No significant differences in cover were observed between the ASET-4000 12% rate without fertilizer and the ASET-4000 rate of 6 or 12% with fertilizer.

In the silt loam soil, the ASET-4000 rate of 6% without fertilizer exhibited substantially higher cover than any other treatment; however, percent cover at this rate was only significantly better when compared to the fertilized control (Table 20, FIG. 26).

FIG. 25 is a chart showing percent cover (%) of perennial ryegrass in a sandy soil at Ft. Lauderdale, Fla., in 2013.

Table 19 is a tabulation of the data shown in FIG. 25:

Date-2013

| Treatments | Fertilizer | 13-Aug | 16-Aug | 22-Aug |
|---|---|---|---|---|
| Untreated | Yes | 19.00 | 20.00 | 18.33b |
| ASET 6% | No | 19.33 | 24.33 | 21.67b |
| ASET12% | No | 2.33 | 30.00 | 33.33a |
| ASET 6% | Yes | 26.67 | 28.33 | 28.33ab |
| ASET12% | Yes | 23.33 | 21.67 | 26.00ab |
| Untreated | No | 21.67 | 21.67 | 18.67b |
| Significance | | NS | NS | * |

FIG. 26 is a chart showing percent cover (%) of perennial ryegrass in a silt loam soil at Ft. Lauderdale, Fla., in 2013.

Table 20 is a tabulation of the data shown in FIG. 26:

Date-2013

| Treatments | Fertilizer | 13-Aug | 16-Aug | 22-Aug |
|---|---|---|---|---|
| Untreated | Yes | 0.67 | 0.67 | 5.17 b |
| ASET 6% | No | 10.67 | 11.33 | 30.00 a |
| ASET12% | No | 2.67 | 2.67 | 11.00 ab |
| ASET 6% | Yes | 13.50 | 13.67 | 24.00 ab |
| ASET12% | Yes | 7.67 | 7.00 | 20.00 ab |
| Untreated | No | 8.00 | 7.67 | 20.00 ab |
| Significance | | NS | NS | * |

### A. Experimental Conclusions

In each of the aforementioned studies ASET-4000 seed coating has been shown to improve emergence and percent cover of Kentucky bluegrass, tall fescue, seashore paspalum, and perennial ryegrass. Studies were conducted under a variety of fertility, irrigation (including saline water) and soil regimes. Varietal differences, as well as response to fertility and irrigation regime were evident. Two trials evaluated response to salinity, an agar trial in New Mexico and a field trial in Texas. Results from the agar trial suggest a strong positive response to the ASET-4000 seed coating in seashore paspalum; however, the field trial in Texas did not show a significant response to seed coating in tall fescue (perhaps because of extreme conditions experienced at this site).

Kentucky bluegrass trials responded well to the 6% ASET-4000 coating under reduced irrigation in the field, as well as under greenhouse conditions. However, the 12% ASET-4000 seed coating was not evaluated in either of these trials. In the field, under deficit irrigation (50% ET), treated seeds had significantly higher percent cover compared to untreated but overall percent cover was substantially reduced compared to tall fescue and perennial ryegrass trials evaluated at the same location.

Perennial ryegrass seeds coated with ASET-4000 performed well at all locations. Results indicate both the 6% and 12% rates improved cover at the Florida site with the exception of water repellent soils which performed best at the 6% rate of ASET-4000. Fertility trials using perennial ryegrass indicate that coated seeds in a nutrient limiting environment (no supplemental fertilizer) outperformed uncoated seeds with and without fertilizer as well as treated seeds receiving supplemental fertilizer. No significant benefit to using the higher rate of ASET-4000 (12%) was observed here. Fertility trials conducted in Florida were not as conclusive, indicating improvements to final cover associated with ASET-4000 treated seed relative to the control only. Limited significant differences among fertility supplements and seed treatments were observed otherwise.

In Greenhouse studies in Florida, tall fescue responded to seed treatments with significantly higher cover only at the end of the observation period with no benefit observed when planted to a water repellant soil under deficit irrigation. In most cases the 12% rate yielded significantly better results compared to the 6% rate of ASET-4000. Field trials indicate a 6% rate of ASET-4000 significantly improved cover relative to the control under deficit irrigation in New Mexico and no significant benefit to seed coating (12% rate) was observed at the Texas location where soils were saline and conditions harsh.

Table 21 that follows summarizes results from the 2013 suite of research. Most grasses responded well to the 6 or 12% rate of ASET-4000. In some cases, no significant benefit to using the higher rate of ASET-4000 was observed. Coated seeds also seem to perform best in a nutrient limiting environment, and outperformed coated and uncoated seeds receiving supplemental CaNO₃. Tall fescue, in greenhouse trials, seemed to be most sensitive to water repellency and water deficits, showing no significant benefit to seed treatments under extreme conditions. Field trials, however, indicate that percent cover in perennial ryegrass and tall fescue were nearly unaffected by water limitations where the ASET-4000 seed coating at 6% was used. Kentucky bluegrass also exhibited a benefit to receiving ASET-4000 relative to the control (greenhouse and field trials), however, overall percent cover declined substantially under water limiting conditions. A single salinity trial showed promise in seashore paspalum and consequent greenhouse trials indicate improved percent cover where seeds received the ASET-4000 seed treatment at the 6% rate.

TABLE 21
Results summary table for all 2013 trials by location, trial type, and turf grass variety.

| | TRIAL | | | | FER- | SEED | |
|---|---|---|---|---|---|---|---|
| LOCATION | TYPE | TURF TYPE | IRRIGATION | SOIL | TILITY | COAT | RESULT |
| New Mexico | Field | Kentucky Bluegrass | 50 or 100% ET | Sandy | | 0, 6% | Improved Cover Under Deficit Irrigation |
| | | | | loam | | | Only |
| Penn State U. | Greenhouse | Kentucky Bluegrass | 0.75 in./week | Slit | | 0, 6% | Improved Emergence, Seedling Vigor & |
| | | | | loam | | | cover |
| New Mexico | Greenhouse | Perennial Ryegrass | | | | 0, 6% | Improved Cover- First Day, Trend for |
| | | | | | | | Higher Cover |
| New Mexico | Field | Perennial Ryegrass | 50 or 100% ET | | | | Improved Cover Under Deficit Irrigation |
| U. Florida | Greenhouse | Perennial Ryegrass | 0.25 in./day | Fine | | 0, 6, 12% | 6 and 12% ASET Improved Cover. Best |
| | | | | sand | | | w/12% |
| U. Florida | Greenhouse | Perennial Ryegrass | 0.25 in./2 days | Fine | | 0, 6, 12% | 6 and 12% ASET Improved Cover. Best |
| | | | | sand | | | w/12% |
| U. Florida | Greenhouse | Perennial Ryegrass | 0.25 in./day | OGS | | 0, 6, 12% | 6 or 12% ASET Improved Cover |
| U. Florida | Greenhouse | Perennial Ryegrass | 0.25 in./2 days | OGS | | 0, 6, 12% | 6% ASET Improved Cover |
| U. Florida | Greenhouse | Perennial Ryegrass | 0.25 in./day | Sand | CaNO3 | 0, 6, 12% | 12% Without CaNO3 Improved Final |
| | | | | | or None | | Cover |
| U. Florida | Greenhouse | Perennial Ryegrass | | Slit | CaNO3 | 0, 6, 12% | 6% Without CaNO3, Better Compared to |
| | | | | loam | or None | | Fertilized Control |
| Penn State U. | Greenhouse | Perennial Ryegrass | | | CaNO3 | 0, 6, 12% | 6 or 12% ASET, Improved Turf Quality in |
| | | | | | or None | | Unfertilized Plots |
| New Mexico | Agar | Seashore Paspalum | 0.6, 10 or 20 ds/m | | | 0, 6% | Improved Germination |
| New Mexico | Greenhouse | Seashore Paspalum | | | | 0, 6% | Improved Cover-All Dates |
| New Mexico | Field | Tall Fescue | 50 or 100% ET | | | 6% | Improved Cover Under Deficit Irrigation |
| Texas Tech | Field | Tall Fescue | Irrigated | Sandy | | 12% | 12% Improved Cover |
| | | | | loam | | | |
| U. Florida | Greenhouse | Tall Fescue | 0.25 in./day | Fine | | 0, 6, 12% | 12% ASET Improved Final Cover |
| | | | | sand | | | |
| U. Florida | Greenhouse | Tall Fescue | 0.25 in./2 days | Fine | | 0, 6, 12% | 6 and 12% ASET Improved Cover. Best |
| | | | | sand | | | w/12% |
| U. Florida | Greenhouse | Tall Fescue | 0.25 in./day | OGS | | 0, 6, 12% | 12% Improved Cover |
| U. Florida | Greenhouse | Tall Fescue | 0.25 in./2 days | OGS | | 0, 6, 12% | |

Additional testing was conducted during spring of 2015 to demonstrate that an amino acid treated seed according to the present disclosure outperforms amino acid spray applications. In these trials, ASET-4000 6% was used as at the osmotic regulator coating of the seed. ASET-4000 6% is equal to a spray application of 1.43-ml/sq. meter in 80-ml/sq. meter.

A Greenhouse Trial A was conducted with perennial ryegrass seed at Pennsylvania State University, Berks, Pa., to observe and measure germination of perennial ryegrass seed coated with ASET-4000 6% and compare it to an uncoated seed (untreated), and also compare it to uncoated seed in which an equivalent spray application of ASET-4000 6% was applied to the soil surface immediately after seeding and watered-in.

This trial was initiated in the greenhouse on Mar. 24, 2015 and concluded on Apr. 15, 2015. A plastic seeding tray was selected with “cups” measuring 2.5 cm×2.5 cm×4.44 cm. Cups were filled with sand and watered to saturation then allowed to drain. One seed was placed in each well, pressed in, and covered slightly with sand. Each treatment was 20 seeds per replication and replicated 5 times for a total of 100 seeds. After seeding, trays were irrigated with 0.65-1.25 cm of water. For the uncoated seed followed by spray treatment, seeds were placed in the cups and material was sprayed using a CO₂ pressurized backpack sprayer at 40 psi to deliver 80 ml of water per square meter. The spray was applied at a rate of 1.43-ml/sq. meter. Trays were irrigated with 0.65-1.25 cml of water following treatment. No starter fertilizer was used.

The results are summarized in Table 22 below. ASET-4000 6% seed treatment significantly enhanced germination of perennial ryegrass when compared to the untreated seed and the spray application

TABLE 22
Final percent germination of perennial
ryegrass. Penn State University.

| Treatment | Final Percent Germination |
|---|---|
| ASET-4000 6% | 95.0 a |
| Untreated Seed | 82.0 b |
| Untreated Seed fb ACA 2786 | 84.0 b |
| LSD P = 0.05 | 9.08 |

A Greenhouse Trial B was also conducted to observe and measure emergence of perennial ryegrass seed coated with ASET-4000 6% and compare it to uncoated seed (untreated), and also compare it to an uncoated seed in which an equivalent spray treatment was applied to the soil surface immediately after seeding and watered-in.

The trial was initiated in a greenhouse on Mar. 17, 2015 and concluded on Apr. 14, 2015. Plastic pots measuring 6.67 cm×6.67 cm×11.45 cm were filled with sand and watered to saturation then allowed to drain to reach field capacity. All pots were seeded with perennial ryegrass at a rate of 39-g/sq. meter. Seed was hand sown onto the surface of the sand, pressed into the sand then top dressed with additional sand. Pots that were receiving spray treatment were seeded, then sprayed with 1.43 ml/sq. meter using a CO₂ pressurized sprayer at 40 psi to deliver 80 ml of water per square meter. After seeding, all pots were irrigated with 1.3 cm of water. No starter fertilizer was used.

The results are summarized in Table 23 and Table 24 below. ASET-4000 6% seed treatment increased establishment and height of perennial ryegrass when compared to untreated seeds and spray applications of. Increased height indicates a plant was healthier. It is also important to note that the ASET-4000 6% coated seed was the first to germinate.

TABLE 23
Percent establishment of perennial ryegrass as affected
by various amino acid applications. PSU (2015)

| | Days After Seeding (DAS) | | | | | | | | | |
|---|---|---|---|---|---|---|---|---|---|---|
| Treatments | 5 | 7 | 9 | 13 | 16 | 19 | 21 | 23 | 25 | 28 |
| ASET-4000 | .50a | 1.6a | 7.0a | 10.0a | 15.0b | 18.0b | 22.4b | 27.0b | 35.0a | 50.0a |
| 6% | | | | | | | | | | |
| Untreated | 0a | 1.8a | 8.0a | 16.0a | 21.0a | 27.0a | 36.0a | 41.0a | 45.0a | 46.0a |
| Seed | | | | | | | | | | |
| Untreated | 0a | 1.4a | 7.0a | 19.6a | 21.0a | 25.0a | 34.0a | 41.0a | 45.0a | 48.0a |
| Seed fb | | | | | | | | | | |
| ACA 2786 | | | | | | | | | | |
| LSD P = 0.05 | 0.00 | .78 | 2.82 | 9.43 | 4.10 | 4.51 | 5.07 | 9.13 | 9.18 | 8.83 |

TABLE 24
Height of perennial ryegrass as affected by
various amino acid applications. PSU (2015).

| Treatments | Plant Height (mm) |
|---|---|
| ASET-4000 6% | 72.0a |
| Untreated Seed | 65.0a |
| Untreated Seed fb ACA 2786 | 66.6a |
| LSD P = 0.05 | 15.11 |

A Greenhouse Trial C was conducted to observe and measure germination of Kentucky bluegrass seed coated with ASET-4000 6% and compare it to uncoated seed (untreated), and also compare it to uncoated seed in which an equivalent spray application was applied to the soil surface immediately after seeding and watered-in.

The trial was initiated in the greenhouse on Mar. 24, 2015 and concluded on Apr. 15, 2015. A plastic seeding tray was selected with “cups” measuring 2.5 cm×2.5 cm×4.44 cm. Cups were filled with sand and watered to saturation then allowed to drain. One seed was placed in each well, pressed in, and covered slightly with sand. Each treatment was 20 seeds per replication and replicated 5 times for a total of 100 seeds. After seeding, trays were irrigated with 0.65-1.25 cm of water. For the uncoated seed followed by a spray application, seeds were placed in the cups and material was sprayed using a CO2 pressurized backpack sprayer at 40 psi to deliver 80 ml of water per square meter. The spray application was applied at a rate of 1.43-ml/sq. meter. Trays were irrigated with 0.65-1.25 cml of water following treatment. No starter fertilizer was used. It is important to note that the in this trial seeds were subjected to severe drought that occurred due to a malfunction of the irrigation system. Unexpectedly, but in accordance with the present disclosure, only the ASET-4000 6% coated seeds germinated. Thus, it is concluded that even under severe drought stress, ASET-4000 6% enhances seed germination. In fact, 71% of ASET-4000 6% treated seed germinated under severe drought stress. No other treatment germinated, uncoated seed, or spray application. Results are summarized in Table 25.

TABLE 25
Final percent germination of perennial
ryegrass. Penn State University.

| | First Day | | Mean |
|---|---|---|---|
| | Germination | Final Percent | Germination |
| Treatment | (DAS) | Germination | Time |
| ASET-4000 6% | 8.002 a | 71.0 a | 8.968 a |
| Untreated Seed | 0.000 b | 0.0 b | 0.00 b |
| Untreated Seed fb | 0.000 b | 0.0 b | 0.00 b |
| ACA 2786 | | | |
| LSD P = 0.05 | 0.0038 | 14.09 | 0.2933 |

A Greenhouse Trial D was conducted to observe and measure emergence of Kentucky bluegrass seed coated with ASET-4000 6% and compare it to uncoated seed (untreated), and also compare it to uncoated seed in which a spray application was applied to the soil surface immediately after seeding and watered-in. The trial was initiated in a greenhouse on Mar. 17, 2015 and concluded on Apr. 14, 2015. Plastic pots measuring 6.67 cm×6.67 cm×11.45 cm were filled with sand and watered to saturation then allowed to drain to reach field capacity. All pots were seeded with Kentucky bluegrass at a rate of 15-g/sq. meter. Seed was hand sown onto the surface of the sand, pressed into the sand then top dressed with additional sand. Pots that were receiving spray treatment product were seeded, then sprayed with 1.43 ml/sq. meter using a CO2 pressurized sprayer at 40 psi to deliver 80 ml of water per square meter. After seeding, all pots were irrigated with 1.3 cm of water. No starter fertilizer was used. Again, it is important to note that the seeds were subjected to severe drought that occurred due to a malfunction of the irrigation system. Surprisingly, only ASET-4000 6% germinated. Results are summarized in Table 26 and Table 27 below. Like trial C, under severe drought stress, ASET-4000 6% treated Kentucky bluegrass seed was the only seed to germinate. In fact, 35% of ASET-4000 6% treated seed germinated under severe drought stress. No other treatment germinated. Seed treated with ASET-4000 6% yielded a plant height of 38.4 mm.

TABLE 26
Percent establishment of Kentucky bluegrass as affected
by various amino acid applications. PSU (2015)

| | Days After Seeding (DAS) | | | | | | | | | |
|---|---|---|---|---|---|---|---|---|---|---|
| Treatments | 5 | 7 | 9 | 13 | 16 | 19 | 21 | 23 | 25 | 28 |
| ASET-4000 | 0.0a | .22a | .66a | 4.2a | 10.0b | 17.0b | 25.0b | 30.0b | 31.0a | 35.0 |
| 6% | | | | | | | | | | |
| Untreated | 0a | 0a | 0a | 0b | 0a | 0b | 0b | 0b | 0b | 0b |
| Seed | | | | | | | | | | |
| Untreated | 0a | 0a | 0a | 0b | 0a | 0b | 0b | 0b | 0b | 0b |
| Seed fb | | | | | | | | | | |
| ACA 2786 | | | | | | | | | | |
| LSD P = 0.05 | 0.00 | .369 | .711 | .92 | 0.00 | 2.31 | 5.16 | 7.29 | 6.92 | 8.42 |

TABLE 27
Height of Kentucky bluegrass as affected by
various amino acid applications. PSD (2015).

| Treatments | Plant Height (mm) |
|---|---|
| ASET-4000 6% | 38.4a |
| Untreated Seed | 0.0b |
| Untreated Seed fb ACA 2786 | 0.0b |
| LSD P = 0.05 | 6.57 |

The data supports that a seed treated in accordance with the present disclosure outperforms a bare seed planted with and without a spray application treatment. Seed treated with ASET-4000 6% was the first to emerge when compared to seed treated with a spray application and the untreated seed. Perennial ryegrass and Kentucky bluegrass seed treated with ASET-4000 6% yielded higher germination and establishment rates when compared to seed treated with spray applications and the untreated seed. Even under severe drought stress, Kentucky bluegrass seed treated with ASET-4000 6% seed coating emerged, germinated, and established.

As used in this application, the word about for dimensions, weights, and other measures means a range that is ±10% of the stated value, more preferably ±5% of the stated value, and most preferably ±1% of the stated value, including all subranges therebetween.

It should be noted that where a numerical range is provided herein, unless otherwise explicitly stated, the range is intended to include any and all numerical ranges or points within the provided numerical range and including the endpoints.

It should also be noted that the terms first, second, third, upper, lower, and the like may be used herein to modify various elements. These modifiers do not imply a spatial, sequential, or hierarchical order to the modified elements unless specifically stated.

Although described herein with reference to one or more exemplary embodiments, it will be understood by those skilled in the art that various changes may be made and equivalents may be substituted for elements thereof without departing from the scope of the present disclosure. In addition, many modifications may be made to adapt a particular situation, construction, operation, or material to the teachings of the disclosure without departing from the scope thereof. Therefore, it is intended that the present disclosure not be limited to the particular embodiment(s) disclosed as the best mode contemplated, but that the disclosure will include all embodiments falling within the spirit and scope of the appended claims.

Claimed is:

1. An agricultural composition comprising:
a seed having an outer layer; and
an osmotic regulator coating in contact with the outer layer of the seed,
wherein the osmotic regulator coating comprises between about 0.5-20% of a weight of the seed, and
wherein the seed exhibits enhanced seed germination compared to an uncoated seed.

2. The agricultural composition of claim 1, wherein the osmotic regulator coating is substantially uniform.

3. The agricultural composition of claim 1, wherein the seed exhibits enhanced seed germination under abiotic stress compared to an uncoated seed under abiotic stress.

4. The agricultural composition of claim 1, wherein the enhanced seed germination yields a seedling with faster emergence, more vigor, increased ground coverage, and/or increased stand density compared to a seedling emerging from an uncoated seed.

5. The agricultural composition of claim 4, wherein the osmotic regulator coating is made of at least two separate sublayers, each sublayer having a different component, wherein the component for each sublayer is selected from the group consisting of: an amino acid complex, activated carbon, calcium nitrate, potassium nitrate, and polyvinyl acetate.

6. The agricultural composition of claim 4, wherein the osmotic regulator coating is made of a homogenous layer comprising: an amino acid complex and at least one other component selected from the group consisting of: activated carbon, calcium nitrate, potassium nitrate, and polyvinyl acetate.

7. The agricultural composition of claim 1, further comprising an outer coating disposed about the osmotic regulator coating, the outer coating comprising diatomaceous earth or limestone.

8. The agricultural composition of claim 7, the outer coating encapsulates the osmotic regulator coating.

9. The agricultural composition of claim 7, wherein the outer coating further comprises at least one selected from the group consisting of: polyvinyl alcohol (PVA), polymers and copolymers of polyvinyl acetate, vinylidene chloride, methyl cellulose, acrylic, cellulose, polyvinylpyrrolidone, and polysaccharide.

10. The agricultural composition of claim 1, wherein the osmotic regulator coating comprises an amino acid complex, wherein the amino acid complex comprises at least six amino acids selected from the group consisting of: alanine, arginine, asparagine, aspartic acid, cysteine, glutamic acid, glutamine, glycine, histidine, lysine, methionine, proline, serine, threonine, tryptophan, and valine.

11. The agricultural composition of claim 1, wherein the amino acid complex comprises: alanine, arginine, asparagine, aspartic acid, cysteine, glutamic acid, glutamine, glycine, histidine, lysine, methionine, proline, serine, threonine, tryptophan, and valine.

12. The agricultural composition of claim 1, wherein the osmotic regulator coating is surfactant free.

13. The agricultural composition of claim 1, wherein the osmotic regulator coating further comprises between about 2-10% calcium and 6-15% nitrogen.

14. The agricultural composition of claim 1, wherein the seed is one of a variety of seed selected from the group consisting of grass, fruit, vegetable, corn, and wheat.

15. The agricultural composition of claim 7, further comprising an activated carbon coating disposed between the osmotic regulator coating and the outer coating, wherein the activated carbon coating is present between about 15-20% weight of activated carbon to weight of seed.

16. The agricultural composition of claim 7, wherein the outer coating comprises between about 5-10% weight of polyvinyl acetate to weight of seed.

17. A method comprising:
mixing a plurality of seeds, an amino acid complex, and an aqueous solution of between about 5-12% polyvinyl alcohol, thus forming an osmotic regulator coating that is in contact with an outer layer of each seed, wherein the osmotic regulator coating is present in a range of between about 0.5-20% weight of osmotic regulator coating to weight of seed, and wherein the polyvinyl alcohol is present in a range between about 10-30% weight of aqueous solution to weight of seed;
admixing, onto the first coating, an additional 10-30% weights of aqueous solution to weight of seed of polyvinyl alcohol and a quantity of diatomaceous earth or limestone until dry.

18. The method of claim 17, wherein the mixing and admixing are performed in a seed coater.

19. The method of claim 17, wherein the mixing and admixing is performed using centrifugal forces.

20. The method of claim 17, further comprising: admixing activated carbon onto the first coating in a quantity that is in a range between about 10-30% weight of activated carbon to weight of seed.

21. A method comprising:
planting, in an environment, a seed having an outer layer and an osmotic regulator coating in contact with the outer layer of the seed, wherein the osmotic regulator coating is in a range between about 0.5-20% of a weight of the seed,
wherein the environment is at least one selected from the group consisting of: an environment having abiotic stressors, an environment having reduced water availability, and environment undergoing deficit irrigation techniques, a sandy soil environment, a high salinity soil environment, an environment with high salinity irrigation water, and a fire ravaged soil environment,
whereby the seed exhibits faster germination time than an uncoated seed.
